(19) United States
(12) Patent Application Publication
(10) Pub. No.: US 2025/0209588 A1
(43) Pub. Date: Jun. 26, 2025

(54) SYSTEM, APPARATUS AND METHOD FOR PROVIDING 3D SURFACE MEASUREMENTS WITH PRECISION INDICATION CAPABILITIES AND USE THEREOF

(71) Applicant: CREAFORM INC., Lévis (CA)

(72) Inventors: Mustafa INANOGLU, Grenoble (FR); Sylvain LOISEAU, Fontaine (FR); Marc VIALA, Varces (FR); Jean-Nicolas OUELLET, Saint-Augustin-de-Desmaures (CA); Eric ST-PIERRE, Lévis (CA); Louis HAWLEY, Saint-Agapit (CA)

(21) Appl. No.: 18/847,987

(22) PCT Filed: May 26, 2023
(86) PCT No.: PCT/CA2023/050722

§ 371 Date: Sep. 17, 2024

Related U.S. Application Data
(60) Provisional application No. 63/346,440, filed on May 27, 2022.

(51) Int. Cl. G06T 7/00; G01B 11/24; G06T 7/62; G06T 7/70; G06T 15/08

(52) U.S. Cl. CPC G06T 7/0002; G01B 11/24; G06T 7/62; G06T 7/70; G06T 15/08; G06T 2200/24; G06T 2207/10012; G06T 2207/10024

(57) ABSTRACT

Described is a method for providing a user with measurement precision indications for a photogrammetric system comprising a positioning system with at least one optical device and a measuring instrument by directing a computing device to implement a Graphical User Interface (GUI), receiving information representing locations of visual targets affixed on the surface of the object and on another immobile surface, processing the locations of the visual targets within the field of view of the at least one optical device for deriving information conveying a volume within which 3D measurements of the surface of the object taken by the measuring instrument satisfy a threshold level of precision, and rendering on the GUI a graphical representation including a volumetric shape corresponding to the derived volume within which the 3D measurements of the surface of the object taken by the measuring instrument satisfy the threshold level of precision. Optionally, or in addition, to presenting measurement precision indications on a GUI, data may be generated conveying the measurement precision indications and may be using in other systems in order to improve surface measurement applications including generating a scanning trajectory for a robot in a photogrammetric system.

### TECHNICAL FIELD

This disclosure generally relates to the field of three-dimensional (3D) metrology systems and, more specifically, to methods and devices for deriving measurement precision level information for such systems and assisting a user in improving the measurement precision of such systems. The approach described in the present document may be applied to various types of measurement devices, such as for example scanning and probing devices, used in a wide variety of practical applications, including but without being limited to manufacturing, quality control of manufactured pieces, and reverse-engineering as well as other areas in the level of precision of measurement may be material to the application.

### BACKGROUND

Photogrammetric systems integrating one, two or more cameras are used for the measurement of 3D points of a surface of a fixed object where one wishes to extract geometric parameters about the shape of the object. For that purpose, a photogrammetric system (or positioning system) will track movements of a measuring instrument in space, the measuring instrument being typically a tactile (touch) probe and/or an optical sensor for measuring coordinates of 3D points on the surface of the fixed object. These coordinates are measured in the coordinate system of the measuring instrument that is either moved manually (by an operator) or mechanically (by a system such as a robot) to successively capture several 3D measurements or groups of 3D measurements on the surface of the object. Combining the 6 degrees of freedom (6 DoF) of movement of the measuring instrument, namely three rotations and three translations, also called “the pose of the measuring instrument”, with 3D measurements of points of the surface of the fixed object makes it possible to transform every 3D measurement into a common coordinate system attached to the object.

Many applications of 3D metrology require highly precise measurements, on the order of a few tens of microns, in some cases within working volumes of several cubic meters. Measurements of such precision can be affected by even small displacements between the object and the measuring instrument, such as displacements caused by vibrations in the environment where the object is located. To compensate for such variations in the measurement process, photogrammetric systems (also referred to as positioning systems in the present application) have been developed that use visual targets that are affixed to the object and/or to a rigid surface that is still with reference to the object. The visual targets are generally in the form of adhesive units with a surface that is retroreflective with respect to light emitted from the photogrammetric system, such as Lambertian surfaces, retroreflective paper, and/or light emissive targets. The targets remain visible within the field of view of the mostly stationary photogrammetric system and allow for compensating for movements between the object, the photogrammetric system, and the measuring instrument. It is thus possible to reach an increased level of precision without using equipment such as isolation tables.

The level of precision that may be obtained for each 3D measurement is highly dependent on the number and position of the visual targets affixed to the object and/or to the rigid surface that is still relative to the object. To ensure that level of precision, it is thus important to adequately distribute the visual targets on the surface of the object (or rigid surface) visible to the photogrammetric (or positioning system) camera(s). The visual targets are generally placed on the object and/or on the rigid surface by a technician who typically will position the targets based on his experience and with a certain level of randomness. In some cases, the technician may be provided with high level guidance for positioning the visual targets, such as advice recommending placing the target in a non-uniform geometric pattern.

Although providing technicians with some general rules such as non-uniformity of the targets may help, such approaches often fail to suitably guide the technician in the choice of the number and/or positioning of the visual targets for a given surface measurement job. Such approaches also fail to validate whether a certain number and/or positioning of the targets will allow the obtained 3D measurements of an object to meet a specific desired level of precision given requirements of the particular job in which the metrology system is being used. In effect, the current approach is highly reliant on the professional judgment and expertise of the technician and is based, to a certain degree, on trial and error. For some applications, such as in the field of quality control of aeronautic components where high levels of precision are required, this may lead to inadequate results.

Another challenge associated with 3D scanning and levels of precision arises when the measuring instrument is mounted to a robot that moves the three-dimensional (3D) metrology system along a trajectory to obtain 3D measurements of a surface of an object. Conventional systems for generating/designing trajectories for the robotic arm for use in performing a scan typically fail to suitably account for levels of precision of the 3D data that may be obtained. As a result, obtaining 3D data with a desired level of precision often requires considerable skill from the part of the technician and/or a lengthy trial and error process to design and select a suitable trajectory, which adds to the time and cost associated with performing a suitable 3D scan.

Against the background described above, it is clear that there remains a need in the industry to provide improved processes and devices increasing the confidence of a user in the precision of 3D measurements that alleviate at least some of the deficiencies of the existing devices and methods.

### SUMMARY

This Summary is provided to introduce a selection of concepts in a simplified form that are further described below in the Detailed Description. This Summary is not intended to identify all key aspects and/or essential aspects of the claimed subject matter.

The present disclosure presents, amongst others, systems and method that may assist in predicting whether a given visual target distribution in three-dimensional (3D) metrology systems will meet one or more desired levels of precision of the 3D measurements over an area of interest on the object. This approach may also allow more easily identifying potential causes of loss of precisions in the measurements, for example resulting from a problem with the measurement system equipment itself (e.g., a fault or malfunction in one or more of the measurement devices) or resulting from improper measurements methodology, such as attempting to obtain 3D measurements from a surface of an object with an insufficient number and/or inadequate positioning of visual targets.

Amongst others, disclosed herein are methods and systems that provide indicators of the quality of 3D measurements of an object being measured by a measuring instrument within a field of view of a positioning system. The system may present an operator with a graphical representation displayed on a display screen of the levels of precision of the 3D measurements of a given configuration of the measuring instrument, the object being measured, and the visual targets on or near the object. The graphical representation of the levels of precision of the 3D measurements can be in the form of a displayed graphical volumes that guides the operator in placement of the measuring instrument being used relative to the object being measured, both the object and the measuring instrument being tracked by the positioning system. The system can validate whether the distribution of visual targets on the object is adequate either before the measurement process begins or in real time to ensure that surface measurements meet a required level of precision.

In some implementations, the displayed graphical representation may include one or more bounding envelopes displayed on a graphical user interface (GUI) that convey one or more volumes of measurements with levels of precision meeting one or more required levels of precision. Using visual feedback of this type, the user can ensure that the object to be measured is encompassed within the bounding envelopes and make adjustment when it is not. Adjustments may include, for example, displacing the measuring instrument so that it is closer to (or further from the object) and/or adding one or more additional visual targets on or near the object in order to improve the level of precision of the measurements.

According to one aspect of the disclosure, described is a method for providing a user with measurement precision indications for a photogrammetric system, the photogrammetric system comprising a positioning system with at least one optical device and a measuring instrument configured to take 3D measurements of a surface of an object, the method comprising (a) receiving, at the computing device, information representing locations of visual targets within a field of view of the at least one optical device, wherein the visual targets include object visual targets affixed on at least one of the surface of (i) the object and (ii) on another surface immobile relative to the surface of the object, (b) processing, at the computing device, the locations of the visual targets within the field of view of the at least one optical device for deriving information conveying a volume within which 3D measurements of the surface of the object taken by the measuring instrument satisfy a threshold level of precision, and (c) releasing data conveying the derived volume within which the 3D measurements of the surface of the object taken by the measuring instrument satisfy the threshold level of precision thereby providing the user with the measurement precision indications for the photogrammetric system.

Specific implementations may include one or more of the following features: the visual targets within the field of view the at least one optical device may include the one or more object visual targets and one or more measuring instrument visual targets affixed to the measuring instrument. In some embodiments, deriving the information conveying the volume within which 3D measurements of the surface of the object taken by the measuring instrument satisfy the threshold level of precision may include (a) processing the locations of the visual targets within the field of view of the at least one optical device to derive (i) a first pose estimation corresponding to a pose of the measuring instrument with respect to the positioning system, and (ii) a second pose estimation corresponding to a pose of the object with respect to the positioning system, (b) processing the first pose estimation and the second pose estimation to derive precision indicator values for a plurality of voxels in the field of view the at least one optical device, and (c) processing the precision indicator values for the plurality of voxels in the field of view the at least one optical device and the threshold level of precision to derive the volume within which 3D measurements of the surface of the object taken by the measuring instrument satisfy the threshold level of precision. In some alternative embodiment, deriving the information conveying the volume within which 3D measurements of the surface of the object taken by the measuring instrument satisfy the threshold level of precision may include (a) processing the locations of the one or more measuring instrument visual targets within the field of view of the at least one optical device to derive a first pose estimation corresponding to a pose of the measuring instrument with respect to the positioning system, (b) processing the locations of the one or more object visual targets within the field of view of the at least one optical device to derive a second pose estimation corresponding to a pose of the object with respect to the positioning system, (c) processing the first pose estimation and the second pose estimation to derive precision indicator values for a plurality of voxels in the field of view the at least one optical device, and (d) processing the precision indicator values for the plurality of voxels in the field of view the at least one optical device and the threshold level of precision to derive the volume within which 3D measurements of the surface of the object taken by the measuring instrument satisfy the threshold level of precision. In some implementations, processing the first pose estimation and the second pose estimation to derive the precision indicator values may include (a) processing the first pose estimation and the second pose estimation to derive a compound pose estimation corresponding to a pose of the measuring instrument with respect to the object, and (b) processing the compound pose estimation to derive the precision indicator values for the plurality of voxels in the field of view the at least one optical device. In some practical implementations, the threshold level of precision can be a default threshold or a value specified by the user at the computing device.

In some specific implementations, the method may comprise (a) directing a computing device to implement a Graphical User Interface (GUI) for displaying a visual representation of the field of view of the at least one optical device of the positioning system; (b) processing the data conveying the derived volume to render on the GUI a graphical representation including a volumetric shape corresponding to the derived volume within which the 3D measurements of the surface of the object taken by the measuring instrument satisfy the threshold level of precision, thereby providing the user with the measurement precision indications for the photogrammetric system.

In some practical implementations, the threshold level of precision may be a unique threshold level of precision or may be one of a plurality of threshold levels of precisions. In implementations where the threshold level of precision is one of a plurality of threshold levels of precisions, the method may comprise processing the locations of the visual targets for deriving information conveying a plurality of volumes within which 3D measurements of the surface of the object taken by the measuring instrument, volumes in the plurality of volumes satisfying corresponding specific threshold levels of precision in the plurality of threshold levels of precision. In some specific examples of implementation, the plurality of threshold levels of precision can include two or more distinct threshold levels of precision and the method may include rendering on the GUI a graphical representation of at least two derived volumes in the plurality of volumes within which 3D measurements of the surface of the object taken by the measuring instrument satisfy corresponding threshold levels of precision in the plurality of threshold levels of precision.

In some specific practical implementations, the volumetric shape displayed on the GUI can include a bounding envelope corresponding to the threshold level of precision, where the bounding envelope has a generally spherical or polyhedral shape.

In some specific practical implementations, the threshold level of precision may be a first threshold level of precision and the plurality of threshold levels of precision may include a second threshold level of precision different from the first threshold level of precision. The volumetric shape may include a first bounding envelope corresponding to the first threshold level of precision and a second bounding envelope corresponding to the second threshold level of precision, wherein the second bounding envelope is fully contained withing said first bounding envelope. The volumetric shape may include a bounding box corresponding to a specific threshold level of precision, where the bounding box is generally cubic.

In some specific implementations, information representing the locations of the visual targets may be provided to the computing system by a user.

In some specific implementations, the method may include (a) receiving, at the computing device, information representing locations of one or more additional visual targets, (b) processing, at the computing device, the locations of the visual targets in combination with the locations of the one or more additional visual targets within the field of view of the at least one optical device for deriving updated information conveying an updated volume within which 3D measurements of the surface of the object taken by the measuring instrument satisfy the threshold level of precision, (c) dynamically adapting the GUI to display an updated volumetric shape corresponding to the derived updated volume.

In some specific implementations, the method may include displaying a CAD geometric model of the object on the GUI overlaid with the displayed graphical representation including the volumetric shape corresponding to the derived volume.

In specific practical implementations, the measuring instrument may be embodied in various forms including for example, a touch probe and a handheld optical scanner.

In some implementations, the method may include providing an indication to the user that the measuring instrument is scanning a zone outside the derived volume within which the 3D measurements of the surface of the object taken by the measuring instrument satisfy the threshold level of precision. The indication can include an audible signal, haptic feedback and/or a visual signal. The visual signal may be provided in a plurality if various manners including a color change of the GUI and/or a flashing icon.

In specific practical implementations, the one or more optical devices of the positioning system can include various devices including for example, a camera and/or a laser tracking system.

According to another aspect of the disclosure, described is a computer program product including program instructions tangibly stored on one or more tangible computer readable storage media, the instructions of the computer program product, when executed by one or more processors, performing operations for providing a user with measurement precision indications for a photogrammetric system, the photogrammetric system comprising a positioning system with at least one optical device and a measuring instrument configured to take 3D measurements of a surface of an object, the operations implementing a method of the type described above. In particular, the operations may comprise: (a) receiving, at the computing device, information representing locations of visual targets within a field of view of the at least one optical device, wherein the visual targets include object visual targets affixed on at least one of (i) the surface of the object and (ii) on another surface immobile relative to the surface of the object, (b) processing, at the computing device, the locations of the visual targets within the field of view of the at least one optical device for deriving information conveying a volume within which 3D measurements of the surface of the object taken by the measuring instrument satisfy a threshold level of precision, and (c) releasing data conveying the derived volume within which the 3D measurements of the surface of the object taken by the measuring instrument satisfy the threshold level of precision thereby providing the user with the measurement precision indications for the photogrammetric system.

Accordance to another aspect, a photogrammetric system is presented for generating 3D data relating to a surface of a target object, the photogrammetric system comprising (a) a positioning system having at least one optical device; (b) a measuring instrument configured to take 3D measurements of a surface of the target object; (c) a computing system in communication with the positioning system, the computing system being configured for (i) receiving information representing locations of visual targets within a field of view of the at least one optical device, wherein the visual targets include object visual targets affixed on at least one of (1) the surface of the object; and (2) on another surface immobile relative to the surface of the object; (ii) processing the locations of the visual targets within the field of view of the at least one optical device for deriving information conveying a volume within which 3D measurements of the surface of the object taken by the measuring instrument satisfy a threshold level of precision; and (iii) releasing data conveying the derived volume within which the 3D measurements of the surface of the object taken by the measuring instrument satisfy the threshold level of precision thereby providing the user with the measurement precision indications for the photogrammetric system.

In some specific implementations, the computing system may be configured for (a) implementing a Graphical User Interface (GUI) for displaying a visual representation of a field of view of the at least one optical device of the positioning system, and (b) processing the data conveying the derived volume to render on the GUI a graphical representation including a volumetric shape corresponding to the derived volume within which the 3D measurements of the surface of the object taken by the measuring instrument satisfy the threshold level of precision, thereby providing the user with the measurement precision indications for the photogrammetric system.

In accordance with another aspect, a computer implemented method is provided for generating a scanning trajectory for a robot in a photogrammetric system, the scanning trajectory being comprised of a sequence of robot trajectory segments arranged between a trajectory start point and a trajectory end point. The photogrammetric system comprises a positioning system with at least one optical device and a measuring instrument configured to take 3D measurements of a surface of an object, the object having a set of visual targets affixed to its surface, the robot holding the measuring instrument and being configured to displace the measuring instrument during a scan. The computer implemented method comprises:
a. providing an initial set of candidate robot trajectory segments as options for a specific robot trajectory segment part of the sequence of robot trajectory segments;
b. for each candidate robot trajectory segment in the set of candidate robot trajectory segments:
   i) sampling configurations of the robot along the candidate robot trajectory segment, each sampled configuration corresponding to a positioning of the robot along the candidate robot trajectory segment;
   ii) for each sampled configuration, deriving an associated quality factor at least in part by using the method described herein to obtain measurement precision indications;
   iii) processing the derived quality factors at the sampled configuration of the candidate robot trajectory segment to derive a prediction of scan quality corresponding to the candidate robot trajectory segment;
c. selecting a specific candidate trajectory segment from the initial set of candidate robot trajectory segments for inclusion as the specific robot trajectory segment part of the sequence of robot trajectory segments, the selecting being performed at least in part by processing the derived predictions of scan quality corresponding to the candidate robot trajectory segments in the set of candidate robot trajectory segments, the specific candidate trajectory segment selected being associated with a specific derived prediction of scan quality satisfying a quality factor threshold;
d. releasing the sequence of robot trajectory segments including the selected specific candidate trajectory segment for use in displacing the robot between the trajectory start point and the trajectory end point to obtain 3D measurements of the surface of the object.

In some implementations, the set of candidate robot trajectory segments may include at least one candidate robot trajectory segments, in some cases at least two distinct candidate robot trajectory segments and in some other cases more than two distinct candidate robot trajectory segments.

In some practical implementations, the method may further comprise generating at least one additional candidate robot trajectory segment as an option for the specific robot trajectory segment part of the sequence of robot trajectory segments in absence of a candidate robot trajectory segments in the initial set of candidate robot trajectory segments satisfying the quality factor threshold.

In some implementations, the sequence of robot trajectory segments may include at least one robot trajectory segment between the trajectory start point and the trajectory end point. In some specific implementations, the sequence of robot trajectory segments may include only one robot trajectory segment between the trajectory start point and the trajectory end point. In alternate specific implementations, the sequence of robot trajectory segments includes two or more robot trajectory segments between the trajectory start point and the trajectory end point. In specific implementations, above describes steps a. to c. may be repeated for each robot trajectory segment in the sequence of robot trajectory segments.

In some implementations, the sequence of robot trajectory segments may include a first robot trajectory segment and a second robot trajectory segment immediately succeeding the first robot trajectory segment, wherein a starting point of the second robot trajectory segment corresponds to an end point of the first robot trajectory segment.

In some implementations, the method may further comprises displacing the robot along the scanning trajectory between the trajectory start point and the trajectory end point to obtain 3D measurements of the surface of the object, the scanning trajectory including the sequence of robot trajectory segments.

In accordance with another aspect, a computer implemented method for generating a scanning trajectory for a robot in a photogrammetric system is provided, the scanning trajectory being comprised of a sequence of robot trajectory segments arranged between a trajectory start point and a trajectory end point. The photogrammetric system comprises a positioning system with at least one optical device and a measuring instrument configured to take 3D measurements of a surface of an object, the object having a set of visual targets affixed to its surface, the robot holding the measuring instrument and being configured to displace the measuring instrument during a scan. The method comprises:
a. providing an initial set of candidate robot trajectory segments as options for a specific robot trajectory segment part of the sequence of robot trajectory segments;
b. for each candidate robot trajectory segment in the set of candidate robot trajectory segments:
   i) sampling configurations of the robot along the candidate robot trajectory segment, each sampled configuration corresponding to a positioning of the robot along the candidate robot trajectory segment;
   ii) for each sampled configuration, deriving an associated quality factor at least in part by processing measurement precision indications corresponding to the sampled configuration;
   iii) processing the derived quality factors at the sampled configuration of the candidate robot trajectory segment to derive a prediction of scan quality corresponding to the candidate robot trajectory segment;
c. selecting a specific candidate trajectory segment from the initial set of candidate robot trajectory segments for inclusion as the specific robot trajectory segment part of the sequence of robot trajectory segments, the selecting being performed at least in part by processing the derived predictions of scan quality corresponding to the candidate robot trajectory segments in the set of candidate robot trajectory segments, the specific candidate trajectory segment selected being associated with a specific derived prediction of scan quality satisfying a quality factor threshold;
d. releasing the sequence of robot trajectory segments including the selected specific candidate trajectory segment for use in displacing the robot between the trajectory start point and the trajectory end point to obtain 3D measurements of the surface of the object.

In accordance with another aspect, a computer program product is provided including program instructions tangibly stored on one or more tangible computer readable storage media, the instructions of the computer program product, when executed by one or more processors, performing operations for generating a scanning trajectory for a robot in a photogrammetric system, the scanning trajectory being comprised of a sequence of robot trajectory segments arranged between a trajectory start point and a trajectory end point, in accordance with the above-described methods.

All features of exemplary embodiments which are described in this disclosure and are not mutually exclusive can be combined with one another. Elements of one embodiment or aspect can be utilized in the other embodiments/aspects without further mention. Other aspects and features of the present invention will become apparent to those ordinarily skilled in the art upon review of the following description of specific embodiments in conjunction with the accompanying Figures.

### BRIEF DESCRIPTION OF THE DRAWINGS

The above-mentioned features and objects of the present disclosure will become more apparent with reference to the following description taken in conjunction with the accompanying drawings, wherein like reference numerals denote like elements and in which:

FIGS. 1A and 1B illustrate embodiments of systems used to obtain 3D measurements of a surface of an object in accordance with two specific examples of implementation;

FIG. 2 depicts coordinate systems and homogeneous transformations (including associated covariance matrices) between components of the systems of FIG. 1A or 1B;

FIG. 3A is a functional block diagram of a sub-system for deriving a precision indicator associated with the system of FIG. 1A or the system of FIG. 1B;

FIG. 3B is a flow chart of a process implemented by the sub-system of FIG. 3A for deriving precision indicator in accordance with a specific example of implementation;

FIG. 4A illustrates an envelope of voxels that are calculated to be within an acceptable threshold of precision within a working volume (or field of view) of a positioning system and a simple surrounding bounding box;

FIG. 4B shows a visual illustration of an envelope of voxels associated with levels of precision that are within an acceptable precision threshold within a working volume (or field of view) and a surrounding bounding box within the working volume in accordance with a specific implementation;

FIGS. 5A and 5B are GUIs showing (FIG. 5A) an envelope of voxels that are associated with levels of precision that are within an acceptable precision threshold within a working volume and (FIG. 5A) a surrounding bounding box corresponding to the envelop of FIG. 5A, where a limited number of visual targets are within the working volume in accordance with a specific implementation;

FIGS. 6A and 6B are GUIs showing (FIG. 6A) an envelope of voxels that are associated with levels of precision that are within an acceptable precision threshold within a working volume and (FIG. 6B) a surrounding bounding box corresponding to the envelop of FIG. 6A, where a number of visual targets are within the working volume in accordance with a specific implementation, wherein the number of visual targets in FIGS. 6A and 6B is greater than the number of visual targets in FIGS. 5A and 5B;

FIG. 7 is a flow chart of process for validating 3D measurements in accordance with a specific example of implementation;

FIG. 8 is a GUI showing a Computer Aided Design (CAD) image of an object being measured and a visual indicator conveying levels of precision in accordance with a specific example of implementation;

FIG. 9 is a GUI presenting a warning indicator to a user in accordance with a specific example of implementation to convey that one or more 3D measurements do not meet a minimum level of precision (or are below an acceptable threshold of precision);

FIG. 10 illustrates a displacement of the positioning system of the systems of FIGS. 1A and 1B accordance with a specific example of implementation;

FIG. 11 is a block diagram of the three-dimensional (3D) metrology systems depicted in FIG. 1A or FIG. 1B having a processing system 150 for providing measurement precision indications accordance with a specific example of implementation;

FIG. 12 is a block diagram showing components of the processing module 150 of FIG. 11 in accordance with a specific example of implementation;

FIG. 13 is a flow diagram block diagram showing a method for generating a scanning trajectory for a robot in a photogrammetric system in accordance with a specific example of implementation.

In the drawings, exemplary embodiments are illustrated by way of example. It is to be expressly understood that the description and drawings are only for the purpose of illustrating certain embodiments and are an aid for understanding. They are not intended to be a definition of the limits of the invention.

### DETAILED DESCRIPTION OF EMBODIMENTS

A detailed description of one or more specific embodiments of the invention is provided below along with accompanying Figures that illustrate principles of the invention. The invention is described in connection with such embodiments, but the invention is not limited to any specific embodiment described. The scope of the invention is limited only by the claims. Numerous specific details are set forth in the following description in order to provide a thorough understanding of the invention. These details are provided for the purpose of describing non-limiting examples and the invention may be practiced according to the claims without some or all of these specific details. For the purpose of clarity, technical material that is known in the technical fields related to the invention has not been described in great detail so that the invention is not unnecessarily obscured.

Disclosed herein are methods and systems that provide indicators of the uncertainty of 3D measurements of an object being measured. The uncertainty of 3D measurement may be expressed relative to one or more desired levels of precision. The system can provide an operator a visualization of the precision level of the 3D measurements of object being measured by a given configuration of the measuring instrument used and the visual targets positioning on or near the object. The visualization can be in the form of a bounding volume providing a boundary between 3D pixel locations where levels of precision are within an acceptable threshold and 3D pixel locations where levels of precision are not within the acceptable threshold. In some embodiments, multiple bounding volumes, each associated with a different respective threshold of precision, may be presented in the visualization. Such visualization may be useful in guiding the operator/technician in the placement of the visual targets on the object and/or on a rigid surface still relative to the object in the field of view of the optical device (e.g., camera or laser tracking system) of the positioning system. In some implementations, the system provided may be used to validate whether the distribution of visual targets is adequate either before a measurement process begins or in real time to ensure that surface measurements obtained meet a required level of precision.

Pose of a Measuring Instrument with Respect to an Object Coordinate System

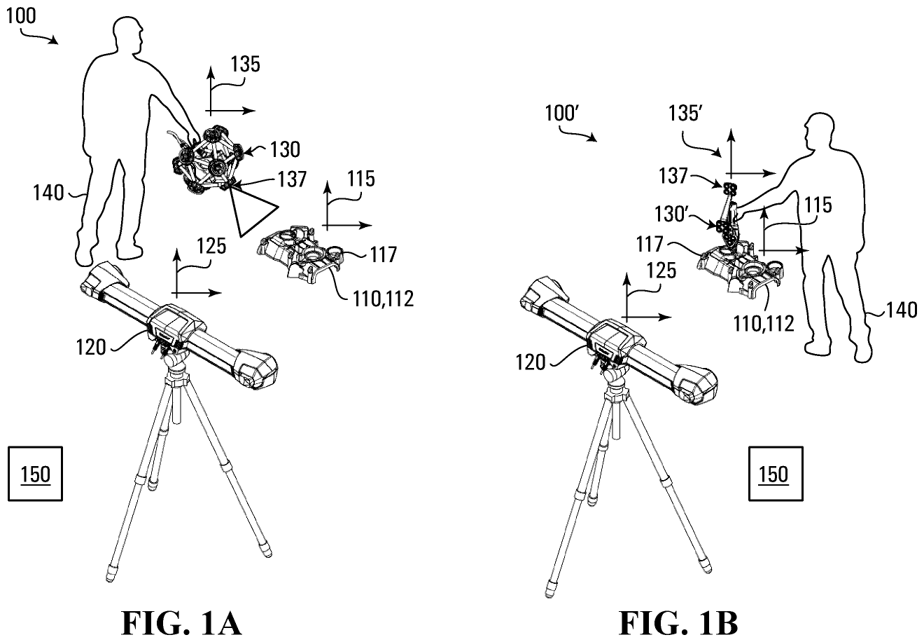

FIGS. 1A and 1B illustrate systems 100 and 100′ that estimate the position and orientation (e.g., the six degrees of freedom (6 DoF) of three translation coordinates and three orientation coordinates) or pose of an object of interest 110 as measured in a coordinate system 115 fixed relative to the object of interest 110. These measurements are taken using a positioning system 120 (a photogrammetry system) and a measuring instrument 130. The positioning system 120 has an associated coordinate system 125 and the measuring instrument 130 has its own associated coordinate system 135. The positioning system 120 (a photogrammetry system) tracks the reference model of the overall systems 100, 100′ and allows for the localization of the measuring instrument 130 or 130′. The measuring instrument can for example be embodied as an optical measuring instrument 130 as in FIG. 1A, or a touch probe measuring instrument 130′ as in FIG. 1B.

The measuring instrument 130 or 130′ is configured to obtain 3D measurements between the measuring instrument 130′ and a point (or set of points in the case of measuring instrument 130) on the surface 112 of the object of interest 110. Since from a given viewpoint the measuring instrument 130 or 130′ can only acquire 3D measurements on the visible or near portion of the surface 112, the measuring instrument 130 or 130′ is moved to a plurality of viewpoints to acquire sets of 3D measurements that cover the portion surface 112 of the object 110 that is of interest. Using the positioning system 120, a model of the object's surface geometry can be built from the set of 3D measurements obtained by the measuring instrument 130 or 130′ and rendered in the coordinate system 115 of the object 110. While 3D measurement of surface points of the object 110 are being obtained by the measuring instrument 130 or 130′, the measuring instrument 130 or 130′ has a pose that itself is tracked by the positioning system 120.

As depicted, the object 110 may have several object visual targets 117 affixed to its surface 112 and/or on a rigid surface adjacent to the object 110 that is still (unmoving) with reference to the object. Additionally, measuring instrument visual targets 137 may be affixed at known locations on the measuring instrument 130 (or 130′). In some specific practical implementations, to properly visualize the object 110, the object visual targets 117 are preferably affixed by a user 140 to the object 110 with a density sufficient to ensure that the overall system 100 or 100′ will always observe at least three object visual targets 117 at once, three being the minimum number of targets required to estimate a six DoF spatial relationship.

In some examples of implementation, the positioning system 120 of FIG. 1A or 1B may be embodied by the CREAFORM™ C-Track™ dual-camera sensor, the optical measuring instrument 130 may be embodied by the CREAFORM™ MetraSCAN 3D™ portable 3D scanner and the touch probe measuring instrument 130′ may be embodied by the CREAFORM™ HandyPROBE™ portable probing system, all commercialized by CREAFORM Inc. (Lévis, Quebec). The MetraSCAN 3D™ portable 3D scanner uses cameras integrated therein for obtaining sets of 3D points on the surface of the object of interest 110. A plurality of measuring instrument visual targets 137 are affixed to the MetraSCAN 3D™ at known positions. The HandyPROBE™ portable probing system also includes a plurality of measuring instrument visual targets 137 affixed thereto at known positions. The C-Track™ dual-camera sensor positioning systems uses the visual targets 137 affixed on the HandyPROBE™ device or the MetraSCAN 3D™ to derive pose information related to the measuring instrument 130 or 130′. While FIGS. 1A and 1B show systems using one positioning system 120, two or more positioning systems analogous to positioning system 120 may be used in alternate embodiments where each positioning system is located at different place around the object to be scanned.

The system 100 (or system 100′) includes a processing system 150 that is configured to provide 3D scanning/image reconstruction capabilities by receiving and processing 3D measurements of the surface 112 of the object of interest 110 obtained by the measuring instrument 130 (or 130′) and positioning information obtained by the positioning system 120 having regard to the measuring instrument 130 (or 130′) and the object 110. In accordance with some specific embodiments, the processing system 150 may also be configured for receiving and processing the positioning information obtained by the positioning system 120 having regard to the measuring instrument 130 (or 130′) and the object 110 amongst other for deriving measurement precision information regarding the 3D measurements obtained by the measuring instrument 130 (or 130′) and for conveying such information to a user of the system 100 (or system 100′), for example via a graphical user interface (GUI) presented on a display screen.

Prior to presenting details pertaining to embodiments of the processing system 150 for deriving and presenting precision information to assist a user of the system 100 (or system 100′), it is useful to consider processes, including mathematical models, that may be used by the system 100 (or system 100′) to providing 3D scanning/image reconstruction capabilities so as to better understand where uncertainties may reside in the measurements leading to reduced levels of precision.

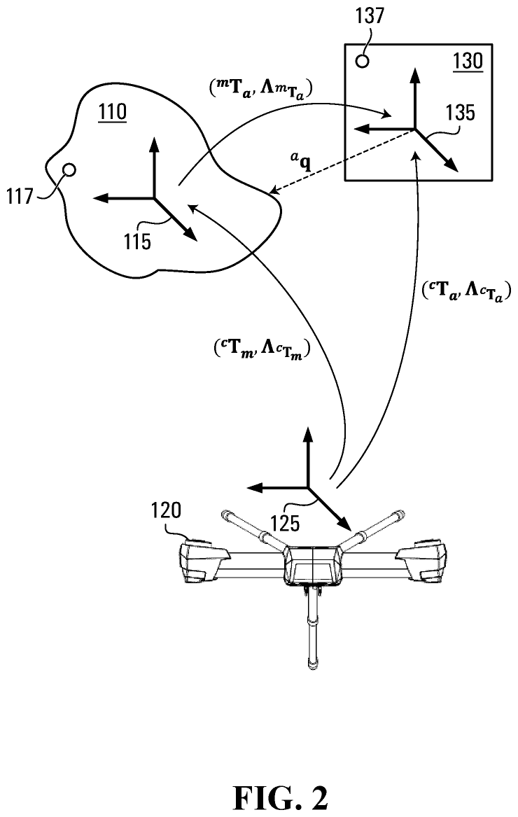

Referring to FIG. 2, in use, the positioning system 120 observes the measuring instrument 130 or 130′ and more particularly its measuring instrument targets 137 and derives information conveying the pose ^{c}Tₐ of the measuring instrument 130 or 130′ with respect to a first reference coordinate system, in this example the coordinate system 125 of the positioning system 120. The positioning system 120 also observes the object of interest 110 and more particularly the object visual targets 117 on its surface 112 (or on a nearby surface that stays still with respect to the object 110) and derives information conveying the object's pose ^{c}Tₘ with respect to the same first reference coordinate system, namely in the example the coordinate system 125 of the positioning system 120.

More specifically, the processing system 150 receives measurements of positions of the measuring instrument targets 137 and the object visual targets 117 as obtained by the positioning system 120 and processes these measurements to derive the pose ^{c}Tₐ of the measuring instrument 130 or 130′ and the pose ^{c}Tₘ of the object 110 with reference to positioning system 120.

In a specific practical implementation, ^{c}Tₘ and ^{c}Tₐ each convey a 6 degrees of freedom pose (6 DoF pose) in space in the form of a rigid transformation, which in a specific implementation may be a 4×4 homogeneous transformation matrix, which is calculated using data received by the processing system 150 from the positioning system 120 that tracks both the object of interest 110 and the measuring instrument 130 or 130′. Using these two poses, ^{c}Tₘ and ^{c}Tₐ, representing the pose of the object 110 with respect to the positioning system 120 and the pose of the measuring instrument 130 or 130′ with respect to the positioning system 120 respectively, the six parameters of the transformation that describes the pose ^{c}Tₐ of the measuring instrument 130 with reference to the object 110 can be calculated from the following equation:

$${}^{m} {T}_{a} = {}^{c} {T}_{m}^{- 1} {}^{c} {T}_{a} \qquad Equation 1$$

Using the above approach, a 3D point (x, y, z) on the object 110 can be transformed from the coordinate system 135 of the measuring instrument 130 or 130′ to the coordinate system 115 of the object 110 using the compounded transformation matrix ^{c}Tₐ. Equation 1 involves the inverse of the pose ^{c}Tₘ of the object 110 with reference to positioning system 120. The compound transformation matrix ^{c}Tₐ thus allows obtaining measurements of points on the surface of the object 110 taken by the measuring instrument 130, while accounting for any relative displacements between the object and the measuring instrument 130 such as those caused by vibrations. The above approach for transforming a 3D point (x, y, z) between different 3D reference coordinate is generally known in the art of metrology and thus will not be described in further detail here.

The person skilled in the art will appreciated that the six parameters of each transformation ^{c}Tₘ and ^{c}Tₐ are measurements and are thus prone to a certain uncertainty and thus have a certain level of precision. A level of precision can be derived for each transformation ^{c}Tₘ and ^{c}Tₐ as well as globally for the compounded transformation ^{m}Tₐ.

### Covariance Matrices for Propagating Levels of Precision (a.k.a Uncertainty)

In some specific implementations, the processing system 150 is configured for deriving metrics of precision for the transformations ^{c}Tₘ and ^{c}Tₐ and for the compounded transformation ^{c}Tₐ. This may be implemented in a number of different manners as will become apparent to the person skilled in the art in view of the present disclosure.

One specific example for representing uncertainties (or levels of precision) of the transformations is using the covariance matrix Λₓ of the resulting parameters x=(x₁, . . . , xₙ). The transformations are each 6-dimensional functions of six (6) parameters.

More specifically, for any function F=(f₁, . . . , fₘ) of m dimensions with fᵢ, a function of n variables, fᵢ(x₁, . . . , xₙ), one may approximate the covariance matrix of F, Λ_{F}, after approximating to the first order (for instance) through linearization of F at a given point in space:

$${Λ}_{F} = J {Λ}_{x} {J}^{T} \qquad Equation 2$$

where Λₓ and Λ_{F} are squared symmetric matrices modeling covariances of size n×n and m×m respectively. J is the Jacobian matrix of function F(x):

$$J = ( \begin{matrix}\partial {f}_{1} / \partial {x}_{1} & … & \partial {f}_{1} / \partial {x}_{n} \\ ⋮ & ⋮ & ⋮ \\ \partial {f}_{m} / \partial {x}_{1} & … & \partial {f}_{m} / \partial {x}_{n}\end{matrix} ) \qquad Equation 3$$

In the present application, m=n=6, and the expressions for J and Λₓ are to be derived.

### Level of Precision (Uncertainty) Propagation for Compound Transformations

When the two transformations ^{c}Tₘ and ^{c}Tₐ are considered independent, the covariance matrix of the transformation ^{m}Tₐ can be derived using the following expression:

$${Λ}_{{m}^{} {T}_{a}} = {}^{m} {Λ}_{a} = {J}_{{c}_{1}} {Λ}_{{c}_{{T}_{m}^{- 1}}} {J}_{{c}_{1}}^{T} + {J}_{{c}_{2}} {Λ}_{{c}_{{T}_{a}}} {J}_{{c}_{2}}^{T} \qquad Equation 4$$

where the Jacobian matrix of the compound transformation ^{m}Tₐ can be expressed as J_{c}=(J_{c}_{₁}|J_{c}_{₂}). One will note that the covariance matrix of the inverse of ^{c}Tₘ is calculated using the following expression:

$${Λ}_{{c}_{{T}_{m}^{- 1}}} = {J}_{i} {Λ}_{{c}_{{T}_{m}}} {J}_{i}^{T} \qquad Equation 5$$

where Jᵢ is the Jacobian matrix of the inverse transformation.

The last two equations (namely equation 4 and equation 5) can then be combined to express the covariance matrix of the compound transformation ^{m}Tₐ from the covariance matrices of the two measured transformations ^{c}Tₘ and ^{c}Tₐ by the positioning system 120. The resulting covariance matrix [symbol] (equivalently ^{m}Λₐ) can be used to express the precision of the transformation between the measuring instrument 130 or 130′ and the object 110 from covariance matrices [symbol] et [symbol] as follows:

$${}^{m} {Λ}_{a} = {Λ}_{{m}_{{T}_{a}}} = {J}_{c 1} {J}_{i} {Λ}_{{c}_{{T}_{m}}} {J}_{i}^{T} {J}_{c 1}^{T} + {J}_{c 2} {Λ}_{{c}_{{T}_{a}}} {J}_{c 2}^{T} \qquad Equation 6$$

Once this expression is set, the expression for the Jacobian matrix of a compound transformation ^{m}Tₐ can be derived, more particularly in the case of a 6 DoF rigid transformation. One will then obtain the expression of the Jacobian matrix for an inverse 6 DoF rigid transformation. Finally, one obtains the covariance matrices [symbol] and [symbol] . These can be obtained numerically from the measured poses estimated by the positioning system 120.

Once the matrix [symbol] has been obtained, it is possible to present the user of the system 100 or system 100′ (e.g., the user 140) with indicators conveying one or more levels of precision of the positioning of the object 110 and the measuring instrument 130 or measuring instrument 130′. In a specific implementation, one indicator may be derived on the basis of the diagonal values of this matrix. Other types of indicators may include the use of x,y,z coordinates, a norm of those three coordinates, or in a simplified form, a GO/NO GO signal based on the norm and an arbitrary threshold that is indicated to the user.

In some cases, a positioning system 120 with a single camera may be sufficient provided a 3D target model of the object visual targets arrangement on the object is made available in advance to the processing system 150. In such an implementation, the 3D target model may be obtained from several viewpoint observations with the single camera positioning system 120.

In some specific implementations, to calculate a pose from the observation of visual targets, one may search for a specific pose that minimizes a 2D image reprojection error obtained by one or more cameras of the positioning system 120 (in FIGS. 1A and 1B).

In some implementations with reference to FIG. 1A and FIG. 1B, when assessing levels of precision associated with measurements, an additional step may be performed to take into account the relative position of a surface point of contact on the object 110 and measuring instrument 130 or measuring instrument 130′ by deriving a level of precision associated with measurements of the surface point. More specifically, with reference to FIG. 1B, where the measuring instrument 130′ is a touch probe measuring instrument 130′, an additional step may be performed to take into account the relative position of an actual surface point of contact “q” on the object 110 with respect to the origin of the coordinate system 135′ of the touch probe measuring instrument 130′. In some practical implementations, this relative position may be obtained after a calibration process has been performed for the measuring instrument 130′. Equivalently, in some implementations with reference to FIG. 1A, where the measuring instrument is an optical scanner 130, a virtual surface point of contact “q” may be defined on the surface of the object 110. For instance, this virtual point of contact “q” may be positioned at a standoff distance along the optical axis of the optical scanner 130. It will be appreciated that while we speak of a single virtual surface point of contact “q”, more than one such virtual point can be defined for the optical scanner 130 since measurements for several points on the surface of the object 110 are concurrently obtained for a given pose of the optical scanner 130. Nevertheless, it is to be appreciated that in some embodiments, a single virtual surface point of contact may be chosen to provide an approximation.

The surface point of contact “q”, either real or virtual, can be represented by a position vector in the coordinate system of the measuring instrument 130 (or 130′), ^{a}q=(^{a}qₓ, ^{a}q_{y}, ^{a}q_{z}, 1), (as shown in FIG. 2). A 4^{th} dimension with the 1 is introduced for representing the surface point of contact “q” in homogeneous coordinates. Using the compound transformation ^{m}Tₐ, the position of “q” can be transformed into the coordinate system 115 of the object 110 as follows:

$${}^{m} q {=}^{m} {T}_{a} {}^{a} q = ( \begin{matrix}{m}^{} {R}_{a} & {m}^{} {t}_{a} \\ {0}_{1 \times 3} & 1\end{matrix} ) {}^{a} q \qquad Equation 7$$

In the above equation, ^{m}Rₐ and ^{m}tₐ are a 3×3 rotation matrix and a 3×1 translation vector respectively. The level of precision (or uncertainty) of ^{m}q can be expressed using the following propagation equation to derive the covariance matrix Λₘ_{_{q}} after assuming that the error on ^{m}Tₐ and ^{a}q are uncorrelated:

$${Λ}_{{}^{m} q} = \frac{{\partial }^{m} q}{\partial {(}^{m} {T}_{a} , {}^{a} q )} ( \begin{matrix}Λ {}^{m} {T}_{a} & {0}_{6 \times 6} \\ {0}_{6 \times 6} & {Λ}_{{}^{a} q}\end{matrix} ) \frac{\partial {}^{m} {q}^{T}}{\partial {(}^{m} {T}_{a} , {}^{a} q )} \qquad Equation 8$$

Assuming that

$${Λ}_{{}^{m} {T}_{a}} \approx ( \begin{matrix}{Λ}_{{}^{m} {R}_{a}} & {0}_{3 \times 3} \\ {0}_{3 \times 3} & {Λ}_{{}^{m} {t}_{a}}\end{matrix} )$$

where the cross-correlation submatrices (the values off the diagonal) are neglected, one can approximate the covariance matrix Λₘ_{_{q}} of the surface point of contact “q” as follows:

$${Λ}_{{}^{m} q} \approx {m}^{} {R}_{a} {Λ}_{{}^{a} q} {}^{m} {{R}_{a}}^{T} + M {Λ}_{{}^{m} {R}_{a}} {M}^{T} + {Λ}_{{}^{m} {t}_{a}} \qquad Equation 9$$

where

$$M = ( \begin{matrix}0 & {m}^{} {t}_{a} ( z ) & {-}^{m} {t}_{a} ( y ) \\ {-}^{m} {t}_{a} ( z ) & 0 & {m}^{} {t}_{a} ( x ) \\ {m}^{} {t}_{a} ( y ) & {-}^{m} {t}_{a} ( x ) & 0\end{matrix} ) . \qquad Equation 10$$

To simplify the computation, the first term of equation 9 may be discarded as being negligible when compared to the last term, assuming the first term is weaker or less material than the remainder of the equation. The expression of the covariance matrix then becomes:

$${Λ}_{{}^{m} q} \approx M {Λ}_{{}^{m} {R}_{a}} {M}^{T} + {Λ}_{{}^{m} {t}_{a}} . \qquad Equation 11$$

In a specific example of implementation, an indicator of a level of precision of measurements of the surface point “q” may be obtained as a scalar value by calculating the square root of the trace of matrix λₘ_{_{q}} as follows:

$$I = \sqrt{Trace ( {Λ}_{{}^{m} q} )} \qquad Equation 12$$

In some embodiments, the precision indicator I may be used to define a certainty distance, for example, from the point q. This distance may be used to determine whether an acceptable level of precision can be associated with the measurements; for example, all points “q” that are within a volume defined by the certainty distance relative to the point q are considered to be within an acceptable level of precision with respect to any pose measurement taken within that volume. Feedback may be provided to the user based on the precision indicator/by way of a graphical illustration (shown for e.g., on a graphical user interface) conveying levels of precision for the measurements displayed on a display screen. The graphical feedback can include, for example, one or more bounding envelopes displayed on a graphical user interface (GUI) that convey one or more volumes with levels of precision meeting one or more required levels of precision.

Optionally, in some practical applications, a multiplicative factor may be applied to set a confidence interval to the precision indicator I, (typically 2 to 3 or more). Assuming an approximate statistical distribution, one can further associate a probability to the confidence interval based on a precision level threshold. One or more default precision level thresholds may be provided or, alternatively or in addition, one ore more acceptable precision level thresholds may be specified by the user of the system (of the type shown in FIG. 1A or 1B for example). The precision indicator I may be compared to this threshold, so that a measurement volume with respect to the surface 112 of the object 110 (or to the object visual targets 117) can be determined where the measurement volume includes points where measurements taken by a measuring instrument 130 will have a precision level within the chosen precision level threshold. This measure of precision can be calculated in real time using the visible object visual targets 117 and visible measuring instrument targets 137 at each time step.

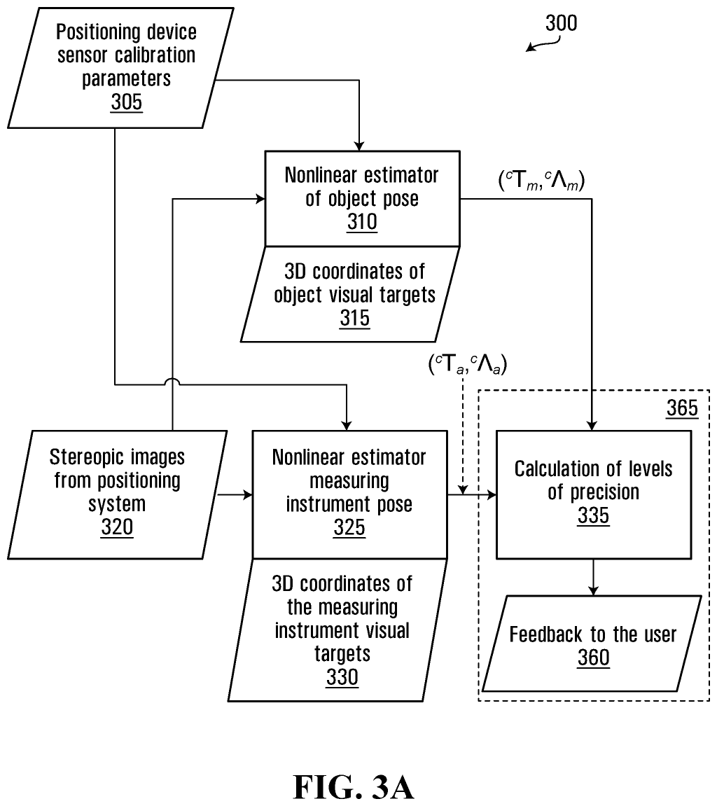

FIG. 3A shows a flow diagram of a process 300 for the calculation of the precision indicator I in accordance with a specific implementation. The steps of the process 300 may be carried out by one or more processors in communication with the positioning device 120 and measuring instrument 130 or 130′ (shown in FIGS. 1A and 1B). The one or more processors may be embodied at least in part in processing system 150 shown in FIGS. 1A and 1B.

In the example depicted, various steps are carried out to provide the matrices that are used as inputs to the precision calculation and feedback block 365, that calculates the levels of precision that are then output to a user. At step 305 of the method 300, calibration parameters of the positioning system 120 are received. The calibration parameters of the positioning system 120 are properties of the particular positioning system 120 being used (e.g., the baseline distance(s) between the two or more cameras that may form the sensing portion of the positioning system 120). The calibration parameters can be stored in a memory accessible by the processing system 150 (shown in FIGS. 1A and 1B).

Next, at step 320, in implementation where positioning system 120 includes two positioning cameras, stereoscopic images are received at the processing system 150. The stereoscopic images are taken by the cameras of the positioning system 120.

The calibration parameters of the positioning device 120 obtained at step 305 are then used at step 310 to process the stereoscopic images received at step 320 to obtain an estimation of the object pose within the stereoscopic images.

At step 315, which may be performed as part of step 310, the 3D coordinates of the object visual targets 117 are derived at least in part by processing the stereoscopic images in combination with the calibration parameters of the positioning device 120.

At step 325, the stereoscopic images received in step 320 are also processed along with the calibration parameters received at step 305 to derive the pose of the measuring instrument 130 with respect to the positioning system 120.

At step 330, which may be performed as part of step 325, 3D coordinates of the measuring instrument visual targets 137 may also be derived by processing the stereoscopic images received in step 320 along with the calibration parameters received at step 305.

Following the above steps 310 and 325, the object pose and instrument pose matrices have been calculated as discussed herein. These matrices are fed as inputs to the precision calculation and feedback block 365.

At step 335, the two poses obtained, namely the object pose derived at step 310 and the measuring instrument pose derived at step 330, are processed to model levels of precision of the measurements obtained by the positioning system 120 with respect to the object's coordinate system.

Following step 335, at step 360, feedback related to the modelled levels of precision may be provided to the user of the system used to obtain 3D measurements of a surface of an object (for example the system shown in FIG. 1 or FIG. 1B). In some practical implementations, feedback may be provided to the user based on the precision indicator I by way of a graphical illustration (shown for e.g., on a graphical user interface of a display screen) conveying levels of precision for the measurements displayed on a display screen. The graphical feedback can include, for example, one or more bounding envelopes displayed on a graphical user interface (GUI) that convey one or more volumes associated with pixels with levels of precision meeting one or more required levels of precision.

FIG. 3B illustrates in greater details sub-steps performed at step 335 to model levels of precision of the measurements obtained by the positioning system 120 with respect to the object's coordinate system.

As depicted, at step 340, the object pose obtained at step 310 and the measuring instrument pose obtained at step 325 are processed to derive precision level information associated to each one of the object 110 and the measuring instrument 130 or 130′. In particular, in some implementations, the two poses obtained at steps 310 and 325 may processed to derive precision matrices for each of the measuring instrument 130 and the object 110 relative to the positioning system 120. The precision matrices may be derived, for example, using the mathematical models described earlier in the present disclosure.

At step 345, the precision matrices for the object 110 and the measuring instrument 130 or 130′ are jointly processed to model a precision of the measuring instrument 130 with respect to the object's coordinate system, for example by deriving a corresponding covariance matrix [symbol] (for example using the mathematical model described above).

Following this, at step 350 a precision indicator I may be derived by processing the precision of the measuring instrument 130 with respect to the object's coordinate system derived at step 345. For example, the precision indicator scalar I may be derived by processing the covariance matrix [symbol] by calculating the square root of the trace of matrix Λₘ_{_{q}} according to equation 12 above. For clarity, a precision indicator I may be calculated in connection with each measurement of a 3D point in a scene being scanned by the measuring instrument 130 and 130′.

Following this, at step 355, the precision indicator I is processed against a precision level threshold (which may be a default precision level, or a precision level threshold selected by the user) to determine whether the derived level of precision falls withing a confidence envelope.

### Use of the Precision Indicator I in Practical Implementations

Multiple scenarios may be contemplated where precision level indicators are determined and conveyed, for example by displaying graphical information on a display screen, to a user interested in levels of precision of 3D measurements obtained by a 3D scanner.

In some embodiments, the precision level indicators may be derived on the basis of a simulated 3D scan of an actual scene. In such a case, the positioning device along with the measuring instrument targets and object targets are positioned and the assessment of the precision level indicators for different locations in the images taking by positioning device may be derived and this in the absence of actual measurements taken by the measuring instrument. Advantageously, such a process may be performed in advance of scanning to validate a setup, for example the setup of the visual targets in the scene both on the measuring instrument and on the object being scanned (or on a surface that is immobile related to the object being scanned) before the actual 3D measurements are obtained.

Alternatively, the measurements and their associated precision level indicators may be used to provide real time validation during live 3D measurements by the measuring instruments to indicate to a user if the measurement setup is providing an acceptable level of precision for the measurements obtained (e.g., if all measurements in areas of interest are within an acceptability threshold of precision) and provide opportunities to adjust the setup. Such adjustments can include introducing additional visual targets to the field of view of the positioning system and/or changing the position of one or more of the visual targets. In some embodiments, the positioning system 120 may alternatively be displaced to ensure that a sufficient number of the object visual targets are visible.

To visualize the measurement precision of different portions of a surface of an object being scanned, the field of view of the positioning system 120 may be represented as a voxel grid that is divided into a plurality of voxels. A typical voxel size for a volume of 17 m³ can correspond to, for example, between 10 mm and 30 mm. It is however to be appreciated that other sizes may be apply in alternative application. The level of measurement precision (or average precision) within each voxel with respect to a given point can be calculated using the method discussed above. The level of measurement precision within each voxel can be visualized and presented to a user interested in taking measurements of an object via a graphical user interface displayed on a computer screen.

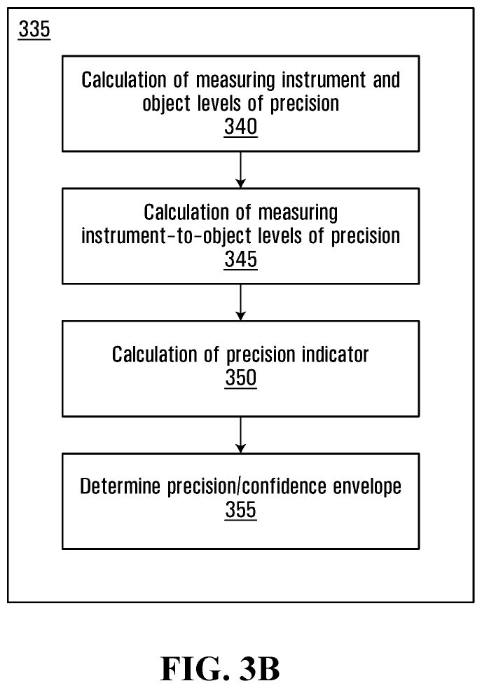

FIGS. 4A and 4B show examples of visual representations for conveying levels of precision of 3D measurements that can be presented on a graphical user interface (GUI) displayed on a display device to a user in accordance with specific embodiments, where the levels of precision of 3D measurements include a visual representation of the precision indicators derived for various voxels in the manner described above.

As illustrated in FIGS. 4A and 4B, a working volume 410 or field of view corresponds to a volume that is captured by the positioning system 120 (e.g., captured by at least one camera of the positioning system) and is the space that can visualized by the positioning system 120 (shown in FIGS. 1A and 1B). An object is positioned within the working volume 410. In the field of view 410, there are one or more (e.g., three, four or more) object visual targets 417 placed on the object (or near the object on a surface that is immobile with respect to the object).

The above-described method for deriving precision indicators may be applied to the working volume 410 to derive a level of measurement precision (or a precision indicator) for each voxel in the working volume 410. Following this, the precision indicators are processed against one or more precision threshold levels in order to classify the voxels as being within a given precision threshold level of not. This classification of the levels of measurement precision of the voxels may be graphically depicted on a display using one or more bounding envelopes, each bounding envelope corresponding to a specific precision threshold level. In the examples depicted in FIGS. 4A and 4B, a single bounding envelope 415 (shown in a lighter shading and corresponding to a specific precision threshold level) is graphically shown, wherein the bounding envelope 415 represents a boundary level of measurement precision. Said differently, the bounding envelope 415 delineates spatial locations (or voxels) where the calculated level measurement precision is considered valid, e.g., within an acceptable level of precision. The one or more precision threshold levels may be set as default values in the system and/or may be specified by the user of the system.

In the example depicted, the bounding envelope 415 defines the volume, or space, within which measurements having levels of precision that meet a desired level may be obtained by the measuring instrument 130 (or 130′). The bounding envelope 415 shown in FIGS. 4A and 4B is generally spherical; however different shapes of the bounding envelope are possible, such as any polyhedron.

In FIGS. 4A and 4B, a second envelope, which we will refer to as a bounding box 420, may also (or instead) be displayed. More specifically, in the example depicted, the bounding box 420 is a cubic that contains all voxels within the bounding envelope 415. In its simplest representation the bounding box 420 is a box with six faces and is intended to be a visual representation that is simple for the user to follow. However, the bounding box 420 can have any other volumetric shape in alternative implementations. For example, FIG. 4B shows a bounding box 425 with a more complex shape. The difference in the shape of the bounding box 425 compared to the bounding box 420 FIG. 4A is due to the position of the bounding envelope 415 within the working volume 410. In FIG. 4B, the bounding envelope 415 is positioned near a portion of the working volume 410. A regular six-faced cubic indicating the acceptable level of precision corresponding to bounding envelope 420 would extend beyond the working volume 410 and inaccurately display to the user that measurements could be taken in that portion of a regularly shaped bounding box. Accordingly, the bounding box 425 is reduced in volume compared to the bounding box 420 of FIG. 4A so that all voxels within the bounding box are within and the actual field of view of the positioning system 120.

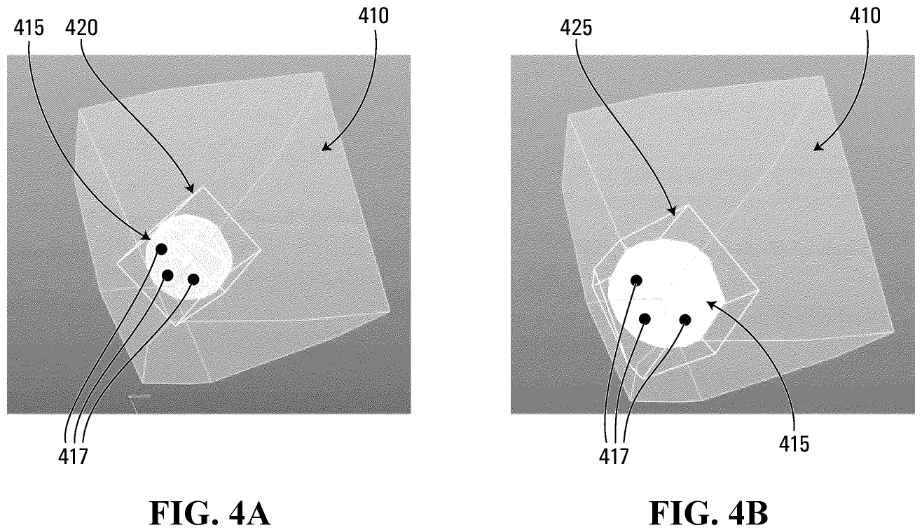

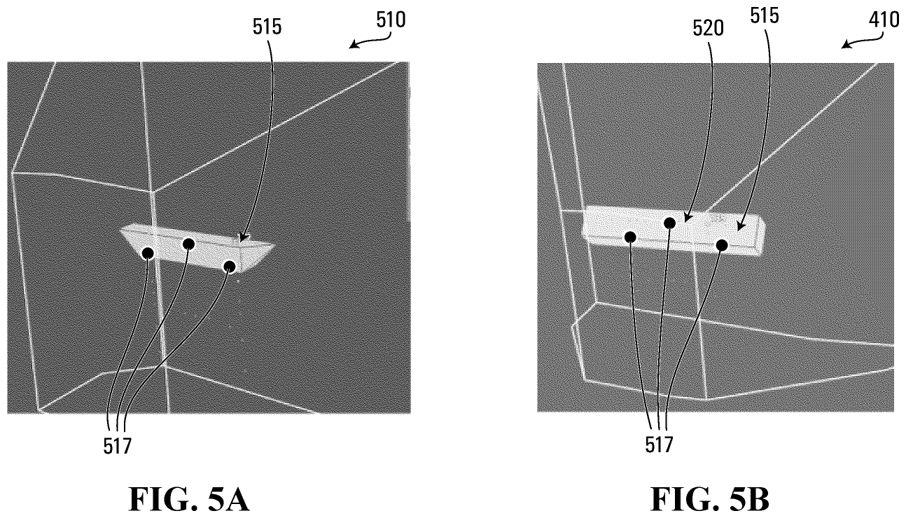

FIGS. 5A to 6B illustrate example changes in the level of precision for different configurations of a 3D measurement system. In FIGS. 5A and 5B, a working volume 510 is depicted along with a specific number of object visual targets 517. A bounding envelope 515 calculated from the visible object visual targets is shown in FIG. 5A and its corresponding bounding box 520 shown in FIG. 5B. In particular in FIGS. 5A and 5B, three object visual targets 517 are shown but it should be understood that any suitable number of targets are possible in alternative implementations.

FIG. 6A and FIG. 6B show a working volume 610 containing object visual targets 617 that correspond to object visual targets 517 of FIGS. 5A and 5B, as well as additional object visual targets 619 (so that the visible object visual targets are greater in number than object visual targets 517). The resulting bounding envelope 615 is shown in FIG. 6A and corresponding bounding box 620 in FIG. 6B. As depicted in the Figures, the presence of the additional visual targets 619 and 617 (relative to visual targets 517) results in a different bounding envelope 615 compared to the bounding envelope 515. The bounding envelope is larger, and more complex, indicating to the user both a larger area of measurement available at the desired level of precision, as well as a more granular boundary. The bounding box 620 likewise is much larger as shown in FIG. 6B when compared to the bounding box 520 of FIG. 5B.

FIGS. 5A to 6B can illustrate the result of a user reaction to the feedback provided by the precision indicators on a GUI. In a first step the user positions the object visual targets 517 as shown in FIGS. 5A, 5B. Observation of the relatively small resulting bounding envelope 515 and/or bounding box 520 may prompt the user to affix the object visual targets 619 in the manner depicted in FIGS. 6A and 6B within the field of view to achieve measurement precision withing a larger volume defined by bounding envelope 615 (or bounding box 620).

The system can validate whether the distribution and/or number of visual targets on the object is adequate either before the measurement process begins or in real time to ensure that surface measurements meet a required level of precision. In some embodiments the user reaction to the feedback provided by the precision indicators on the GUI occurs in real time. That is, the user positions the object visual targets 517 as shown in FIGS. 5A, 5B. The positioning system 120 records the location of the object visual targets 517 and communicates them to the GUI, e.g., over a communication network. Observation of the relatively small resulting bounding envelope 515 and/or bounding box 520 may prompt the user to affix the object visual targets 619 in the manner depicted in FIGS. 6A and 6B. The GUI dynamically updates the display to show the new precision information that is calculated, e.g., the bounding envelope 615 and corresponding bounding box 620.

In some embodiments feedback provided by the precision indicators on the GUI occurs as part of virtual feedback. The user communicates the positions of object visual targets 517 as shown in FIGS. 5A, 5B as would be seen by the positioning system 120. For example, the user inputs the location into the computing device manually or this information is extracted from a file. Observation of the relatively small resulting bounding envelope 515 and/or bounding box 520 may prompt the user to include the additional object visual targets 619 as shown in FIGS. 6A and 6B. The user communicates the position of the additional object visual targets 619 by for example, inputting their location to the computing device. In some embodiments, the location of the object visual targets 619 is already known, and the user can indicate a state of the object visual targets, e.g., toggle them from “off” to “on”. Indicating the object visual targets 619 as off would result in the bounding box and bounding envelope of FIGS. 5A and 5B, while toggling them on would result in the bounding box and bounding envelop of FIGS. 6B and 6B. Accordingly, the user can investigate the measuring precision of a known setup without actually capturing data from the positioning system 120.

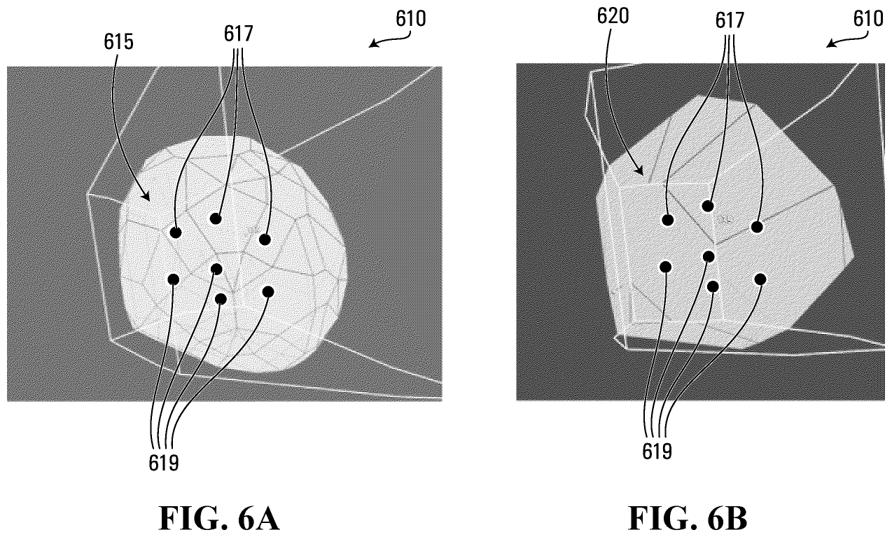

FIG. 7. illustrates the steps of a method 700 a user might follow for adjusting the number and/or positioning of the visual targets so that a desired voxel volume of measurements having a suitable level of precision is obtained. At step 705, the user places object visual targets within the working volume either on the object being scanner itself and/or on a surface that is immobile with reference to the object.

At step 710, the positioning system 120 captures an image of the working volume and precision level indicators are derived for voxels in the working volume, for example using the methods described earlier in the present disclosure.

At step 715, the precision level indicators derived at step 710 are processed against one or more precision level thresholds to derive one or more corresponding bounding envelopes and/or bounding boxes, which may be rendered on a display device along with images of the visual targets so that the user may visualize this information alone with information related to the working volume.

At step 720, based on a visualisation of the bounding envelope(s) and/or bounding box(es), the user then determines at step 720 if the volume of voxel with acceptable level of precision is acceptable (i.e., of the portions of interest of the object of interest lie within the bounding envelope(s) and/or bounding box(es). If step 720 is answered in the negative, the process proceeds to step 725. If step 720 is answered in the negative, the process proceeds to step 701. It is to be appreciated that while step 720 has been described in the present example as being performed by the user (i.e., in person), in alternative embodiments, these steps may be fully or partly automated using suitable image processing algorithms so that the decision is performed (at least in part) by a computing device rather than by a person. The implementation of such image processing algorithms is beyond the scope of this disclosure and will not be described in further detail here.

At step 701, the user may move existing object visual targets and/or add additional object visual targets within the working volume (e.g., moving from a situation such as in FIG. 5A to one such as FIG. 6A). Following this, the process then returns to step 710 in which a new image of the working volume if obtained and new precision level indicators are derived for voxels in the working volume.

These steps (namely steps 710, 715, 720 and 701) can be repeated as many times as required before the user is satisfied that the object to be measured will be suitably contained within a volume where the level of measurement precision will be withing an acceptable threshold. Following this, the process proceeds to step 725.

At steps 725, measurements obtained by the positioning system 120 along with the measuring instrument 130 or 130′ may be obtained and stored in connection with a surface of the object of interest.

The steps of characterizing the working volume (step 710), of viewing the levels of precision of the measurements (step 715) and of optimizing/improving the levels of precision within a desired volume (steps 720, 701+repeat step 710) may be carried out during measurement acquisition activities, in real time. Alternatively, these steps may be carried out before objects are actually measured. For example, object visual targets can be affixed to object mock-ups or trusses within the working volume before an actual object to be measured is placed therein. In other embodiments, the precision can be modelled in software so that the working volume and the object visual targets are modeled using software (rather than using actual physical component of a working volume and object visual targets) and these models are processing to assess a desired configuration of the object visual targets.

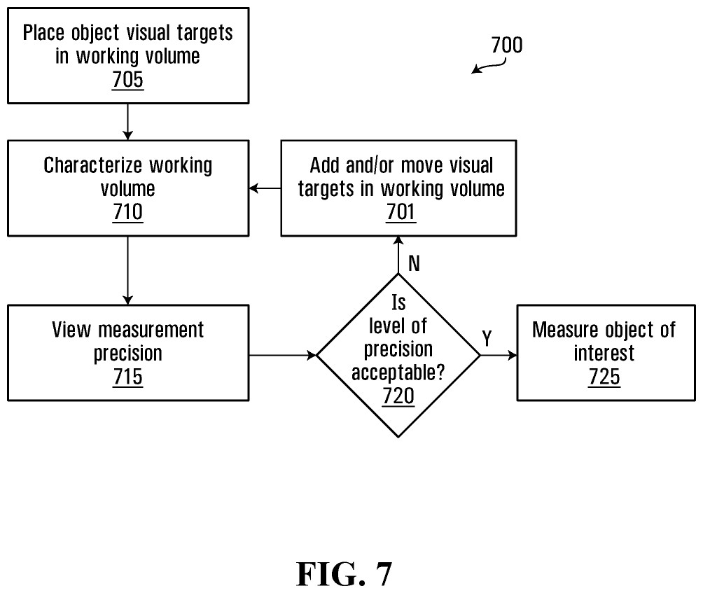

In addition, the object to be measured may be modelled as a CAD geometric model, which be displayed on the screen. FIG. 8 shows an example display screen 800 such as would appear on a GUI, depicting a simplified representation of a CAD model 810 of an object of interest. The CAD model of the object can be positioned within the working volume of the positioning system 120 and measurements of its surface may be simulated using actual or modelled versions of object visual targets 817 positioned on the object (or on a surface immobile with the object).

In the example depicted in FIG. 8, on the display screen 800 the 3D measurements of the surface of the object that are taken by the positioning system are shown as overlaid on the displayed CAD model 810 of the object. The screen 800 can include representations of the object visual targets 817 that are on or fixed relative to the object. The screen 800 can also display visual information conveying which physical locations are within the working volume corresponding to 3D measurement positions where the validity is within a predetermined threshold.

For example, measured voxels (corresponding to pixels on the image displayed on the display screen) can be color-coded or otherwise differentiated to indicate measurement with levels of precision meeting the one ore more threshold levels of the precision. For example, measured voxels (corresponding to pixels on the image displayed on the display screen) such as regions 830 that are beyond an allowable level of precision (e.g., beyond a threshold level of precision) can be shown in a different color from the rest of the surface of the object.

In some embodiments, the measurements and corresponding level of precision indicators provide real-time validation during actual taking of 3D object measurements to indicate to a user whether the measurement setup is providing an acceptable level of precision (e.g., if all points of interest are valid and within an acceptability threshold of precision). Concurrent 3D measurements and precision level calculations provide opportunities for the user to adjust the setup, for example in the manner described with reference to FIG. 7.

The feedback pertaining to the precision levels associated with the measurements may be provided to the user in various manners in addition to displaying information on a display screen. For example, information in the form of an audio signal and/or text message and/or haptic signal and/or other visual signal conveying that the object visual targets should be added or otherwise adjusted may be issued (e.g., a suggestion to the user to affix additional object visual targets or to reposition one or more object visual targets). Alternatively, or in addition, the feedback provided to the user may be in the form of an audio signal and/or text message and/or haptic signal and/or other visual signal conveying a warning that 3D measurements obtained on a surface of interest do not meet a required level of precision threshold. For example, an audio tone or other signal can be emitted when a 3D measurement failing to meet the precision threshold is captured.

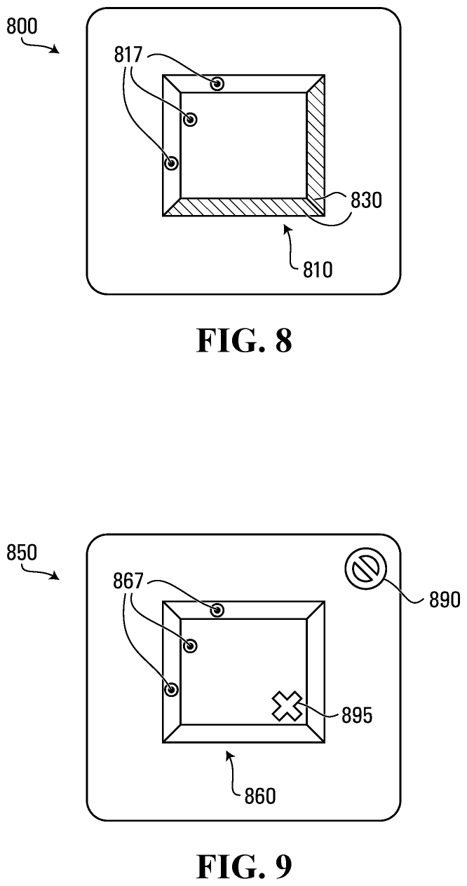

FIG. 9 shows an example screen 850 of a GUI that is displaying a 3D model 860 of the object being measured by the system in real time (including a set of object visual targets 867). A warning in the form of a visual alert, such as for example a blinking or colored pictogram or icon 890, can appear in response to detecting 3D measurements obtained on a surface of interest that do not meet a required level of precision threshold, thereby alerting the user that the position of the measuring instrument has moved outside of the desired precision level zone. In some embodiments, an additional visual indicator such as icon 895 can be displayed to indicate the position near or on the 3D model 860 where the measurement that would outside the precision threshold was taken.

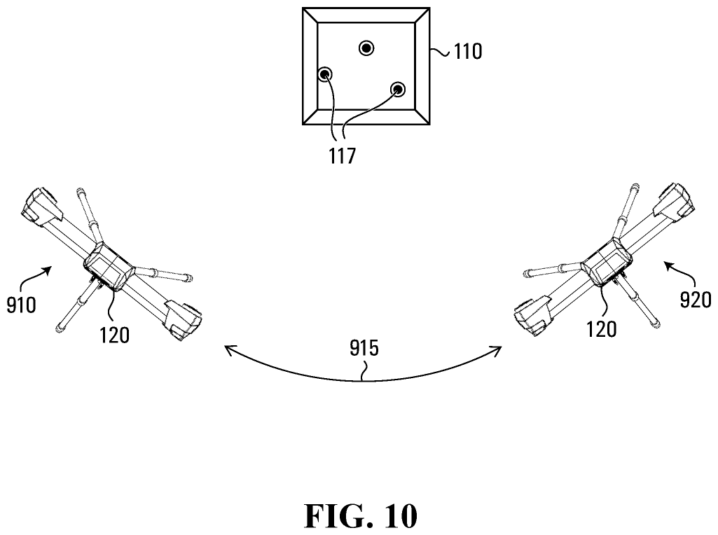

While the example described above with reference to FIGS. 1A and 1B show a positioning system 120 that is stationary, in alternative embodiments, the positioning system may be mobile so a to obtain multiple views. FIG. 10 illustrates a use of the positioning system in a multiview configuration. For some applications, it is possible that the field of view and the working volume of the positioning system is insufficient due to the large size of the object to be measured, and multiple views of the positioning system are necessary. Another multiview situation occurs when it is necessary to measure points in areas where the measuring instrument is not well visible, such as within a hole or behind another portion of the object. Accordingly, the positioning system 120 can be used to validate the levels of precision of object targets 117 on the object 110 while the positioning system 120 is at a first position 910 with respect to the object 110. The positioning system 120 can be moved to a second position 920, where again the level of precision will be validated for the volume as described above. This process can be repeated for additional positions of the positioning system 120, returning at last to the first position 910 to begin the actual measurement process. Since the object visual targets are used as anchor points when displacing the system from one position to the other, another approach would be to divide the displacement in two or more smaller displacements to obtain a better integrated model of object visual targets that is progressively built. The precision assessment remains the same in either instance.

In some specific practical implementations, the measuring instrument may be moved mechanically by a system such as a robot. If measurements are carried out robotically, the calculation of measurement precision as discussed herein can be used in conjunction with robot motion control software that can program robot trajectories to measure objects, such as the CREAFORM™ VXscan-R™.

In such embodiments, the object may be measured by a measuring instrument carried by a robot. The trajectory of the measuring instrument can be simulated and planned before being executed by the robot. Multiple simulations can be carried out to determine one or more trajectories between a trajectory start point and a trajectory end point to be taken by the robot to satisfy a desired level of measurement precision (e.g. to ensure that the measurement precision are within a certain threshold level of precision, for example). One or more trajectories can be taken by the robot, and the trajectory of the measuring device can be discretized into several points/configurations of interest sampled along each of the trajectories.

At sampled configurations along a candidate trajectory between the trajectory start point and the trajectory end point, an error model corresponding to the positioning system may be used to add noise to the simulated coordinates of the visual targets visible from the measuring instrument in order to more accurately simulate observed visual targets. In addition, the error model corresponding to the positioning system may also be applied to the 3D target model as seen by the positioning device in the simulated 2D image generated by the cameras of the positioning device.

In some implementations, a trajectory between the trajectory start point and the trajectory end point may be comprised of a sequence of robot trajectory segments arranged between a trajectory start point and a trajectory end point. In such cases, each of the trajectory segments in the sequence may be derived substantially independently from the others and the trajectory segments in the sequence may then be combined to form the complete trajectory.

The covariance matrices for the measuring instrument and the object may be based on simulated (rather than measured) coordinates. A 3D pose applied to the measuring instrument can be used to compute precision indicators for each simulated object surface point and the precision indicators can be used to optimize a trajectory that meets a certain threshold level of precision.

Optimizations may include, without being limited to, reorienting the measuring instrument (e.g., roll, pitch, yaw), reorient the object (e.g., roll, pitch, yaw), translate and reorient the device (e.g., roll, pitch, yaw, Tx or translation in x, Ty or translation in y, Tz or translation in z) and/or adding (or moving) a (simulated) visual target in the scene. Such optimizations may be integrated in an automated optimization process to minimize the levels of the precision indicator throughout the trajectory.

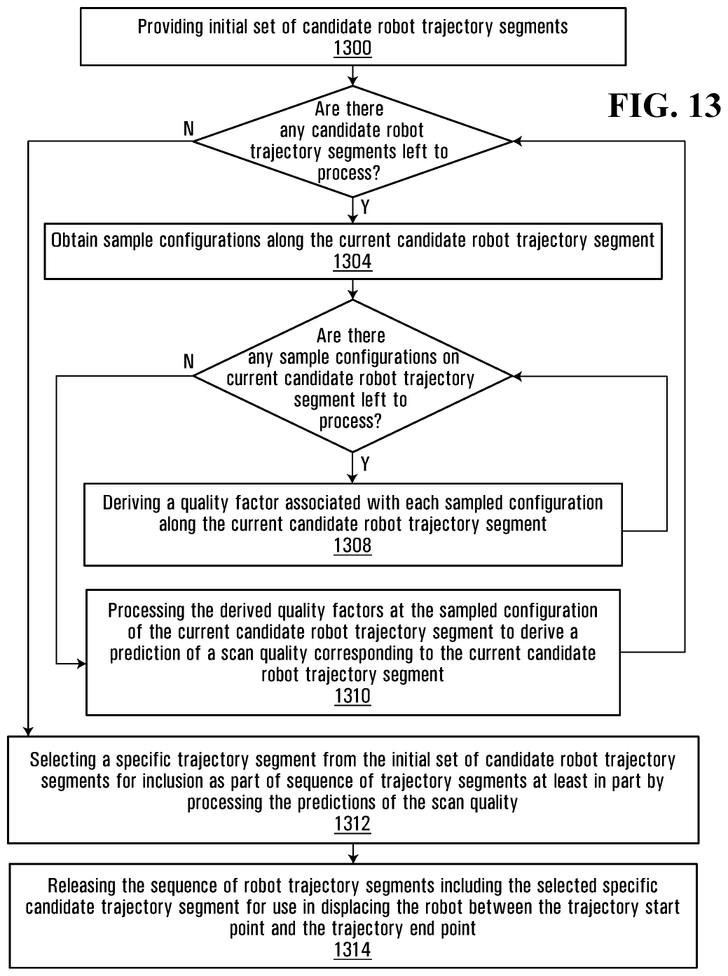

FIG. 13 shows an example of a process for generating a scanning trajectory for a robot in a photogrammetric system to scan a surface of an object. In this example, the scanning trajectory is comprised of a sequence of robot trajectory segments arranged between a trajectory start point and a trajectory end point, wherein the sequence of robot trajectory segments may include only one (a single) robot trajectory segment, two robot trajectory segment or three or more robot trajectory segments arranged in sequence between the trajectory start point and the trajectory end point. As depicted, the method includes the following steps, wherein step a. to c. below (corresponding to steps 1300 to 1312 in FIG. 13) may be repeated for each robot trajectory segments in the sequence of robot trajectory segments between the trajectory start point and the trajectory end point:
a. at step 1300, an initial set of candidate robot trajectory segments is provided and includes one or more options for a specific robot trajectory segment part of the sequence of robot trajectory segments. In some implementations, the set of candidate robot trajectory segments may include a single candidate robot trajectory segment, in some other implementations the set may include at least two distinct candidate robot trajectory segments and in some other implementations the set may include more than two distinct candidate robot trajectory segments.
b. for each candidate robot trajectory segment in the set of candidate robot trajectory segments:
   i) at step 1304, sampled configurations are obtained along the current candidate robot trajectory segment, each sampled configuration corresponding to a positioning of the robot along the current candidate robot trajectory segment;
   ii) for each sampled configuration, at step 1308, an associated quality factor is derived at least in part by processing measurement precision indications derived using the methods described herein in the instant disclosure, for example at least with reference to FIGS. 3A and 3B. For example, this may be performed by:
      STEP 1: performing a simulation using an error model of the positioning device for the 3D target model measurement to add noise to simulated coordinates of visual targets in the set of visual targets visible from the measuring instrument from the sampled configuration along the current candidate robot trajectory segment.
      STEP 2: propagating a measurement uncertainty using the approach described in the present disclosure to obtain measurement precision indicators associated with the sampled configuration.
      STEP 3: processing the measurement precision indicators to derive the quality factor associated with the sampled configuration.
   iii) at step 1310, the derived quality factors at the sampled configuration along the current candidate robot trajectory segment are processed to derive a prediction of a scan quality corresponding to the current candidate robot trajectory segment. For example, deriving the prediction of the scan quality corresponding to the current candidate robot trajectory segment may be performed by processing the quality factors at the sampled configurations of the current candidate robot trajectory segment to derive an overall quality prediction associated with the 3D measurement of the surface of the object.
c. at step 1312, selecting a specific trajectory segment from the initial set of candidate robot trajectory segments provided at step 1300 for inclusion as the specific robot trajectory segment part of the sequence of robot trajectory segments. The selecting is performed at least in part by processing the predictions of the scan quality corresponding to the candidate robot trajectory segments in the set of candidate robot trajectory segments, and wherein the specific candidate trajectory segment selected is associated with a specific derived prediction of scan quality satisfying a quality factor threshold, for example being equal or greater that the quality factor threshold. In specific practical implementation, if none of the trajectory segments in the initial set of candidate robot trajectory segments provided at step 1300 were found to satisfy the quality factor threshold, the process may comprise a step (not shown in FIG. 13) of generating one or more additional candidate robot trajectory segments and repeating steps 1304 1306 1308 1310 and 1312 until either the quality factor threshold has been satisfied or a maximum number of attempts has been performed;
d. at step 1314, the sequence of robot trajectory segments is released for use in displacing the robot between the trajectory start point and the trajectory end point to obtain 3D measurements of the surface of the object, wherein the sequence of robot trajectory segments includes the selected specific candidate trajectory segment.

In some very specific implementations, the sequence of robot trajectory segments may include a first robot trajectory segment and a second robot trajectory segment immediately succeeding the first robot trajectory segment. In such implementations, both the first robot trajectory segment and the second robot trajectory segment are derived using steps 1300 1304 1306 1308 1310 and 1312 of the process depicted in FIG. 13. In some implementations, a starting point of the second robot trajectory segment may be set to generally correspond to an end point of the first robot trajectory segment.

The sequence of robot trajectory segments released at step 1314 may then be used to displace the robot between the trajectory start point and the trajectory end point to obtain 3D measurements of the surface of the object.

As mentioned above, for each sampled configuration, at step 1308, an associated quality factor is derived. The quality factor is intended to convey a level of quality associated with 3D measurements that may be obtained from that sampled configuration. Generally speaking, the greater the level of precision of the measurements obtained, the greater the level of quality of the measurements. In specific practical implementations, the quality factor associated with a sampled configuration may be derived in different ways at least in part by processing the measurement precision indicators derived in accordance with the methods described in the present application.

In a non-limiting example, the quality factor associated with a sampled configuration may be derived by first obtaining measurement precision indications associated with a set of points of a surface being scanned as would be seen by the measuring instrument. For example, measurement precision indications may be obtained for five (5) points on a surface to be scanned, such as at each of four (4) corners of a projected light pattern on the surface to be scanned and at one (1) point near a center area of the projected light pattern. In a specific example, the measurement precision indication at a specific point may be derived by calculating the trace of the covariance matrix described above, i.e. the precision indicator, in another case, it can be derived by calculating the norm of the vectors resulting in the projection of the eigenvectors of the covariance matrix on the normal vector of the plane of the surface observed.

The measurement precision indications for the set of points of the surface may then be combined statistically in order to derive one value representing the quality of the sampled configuration (a.k.a. the quality factor). The manner in which the measurement precision indications may be combined may vary significantly between practical implementations and various embodiments may be contemplated. For example, a sum and/or average and/or weighted sum and/or average of the measurement precision indications may be used to derive the quality factor. Alternatively, the quality factor may be in the form of a scale of discrete values and the combination of the measurement precision indications for the set of points may be used to derive a specific discrete value in the scale of discrete values. In yet another example, the high value of the measurement precision indications amongst the points in the set of points may kept and used as the quality factor and the other values may be disregarded. It is to be appreciated that many other suitable approaches for deriving a quality factor quantifying a level of quality associated with a sampled configuration may be used in alternative implementations, which will become apparent to the person skilled in the art in view of the present disclosure.

It is also to be appreciated that any suitable method known in the art may be used to derive the initial set of candidate robot trajectory segments at step 1300 and the way this initial set is derived is beyond the scope of the present disclosure. In this regard, the reader may refer to one or more of the following documents for additional information, the contents of which are incorporated herein by reference:
i) S. M. LaValle. Planning Algorithms. Cambridge University Press, 2006.
ii) J. C. Latombe. Robot Motion Planning. Kluwer Academic Publishers, Boston, MA, 1991
iii) H. Choset, K. M. Lynch, S. Hutchinson, G. Kantor, W. Burgard, L. E. Kavraki, and S. Thrun. Principles of Robot Motion: Theory, Algorithms, and Implementations. MIT Press, Boston, MA, 2005.
iv) L. Kavraki and J. C. Latombe. Randomized preprocessing of configuration space for fast path planning. In IEEE International Conference on Robotics and Automation, 1994.
v) L. E. Kavraki, P. Svestka, J. C. Latombe, and M. H. Overmars. Probabilistic roadmaps for path planning in high-dimensional configuration spaces. IEEE Transactions on Robotics and Automation, 12 (4): 566-580, 1996.
vi) S. M. LaValle and J. J. Kuffner. Randomized kinodynamic planning. International Journal of Robotics Research, 20 (5): 378-400, May 2001.
vii) D. Aarno, D. Kragic, and H. I. Christensen. Artificial potential biased probabilistic roadmap method. In Proceedings IEEE International Conference on Robotics & Automation, 2004.

In some embodiments, such simulations may also allow a user to take into account variations within an actual measurement scene by programming different trajectories with different conditions, such as different number of object visual targets, different ambient temperature, different threshold levels of precision and the like.

### Practical Example of Implementation for Processing System 150

Those skilled in the art should appreciate that in some non-limiting embodiments, all or part of the functionality previously described herein with respect to the processing system 150 for deriving precision level indicators for the system 100 or 100′ (shown in FIGS. 1A and 1B) or a process for generating a scanning trajectory for a robot in a photogrammetric system (described with reference to FIG. 13) as described throughout this specification, may be implemented using pre-programmed hardware or firmware elements (e.g., microprocessors, FPGAs, application specific integrated circuits (ASICs), electrically erasable programmable read-only memories (EEPROMs), etc.), or other related components.

In other non-limiting embodiments, all or part of the functionality previously described herein with respect to processing system 150 of the system 100 or 100′ may be implemented as software consisting of a series of program instructions for execution by one or more processors. The series of program instructions can be tangibly stored on one or more tangible computer readable storage media, or the instructions can be tangibly stored remotely but transmittable to the one or more processors via a modem or other interface device (e.g., a communications adapter) connected to a computer network over a transmission medium. The transmission medium may be either a tangible medium (e.g., optical or analog communications lines) or a medium implemented using wireless techniques (e.g., microwave, infrared or other transmission schemes).

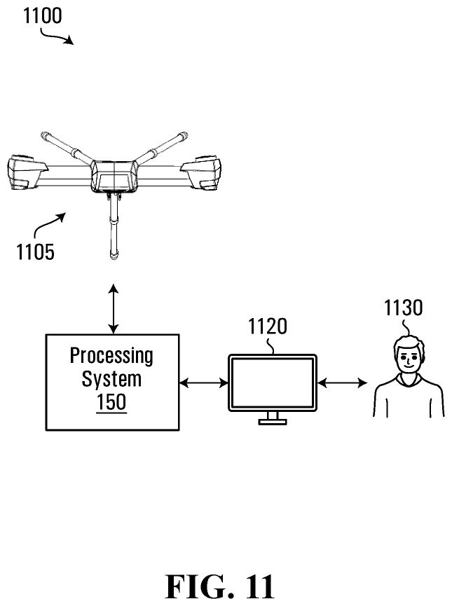

For example, FIG. 11 shows block diagram a system 1100 for characterizing a surface of a 3D object as described above. The imaging process is carried out by the positioning system 1105, which is in communication with processing system 150. The processing system 150 is programmed with instructions for carrying out the methods of the type described above and communicates with a user 1130 via an input/output device 1120 that, in some implementations, may include a display screen. The input/output device 1120 may be configured for receiving user inputs that affect the operations carried out by the processing system 150 and/or may be configured to graphically display results of the precision level indicators to the user 1130.

Those skilled in the art should further appreciate that the program instructions may be written in a number of suitable programming languages for use with many computer architectures or operating systems.

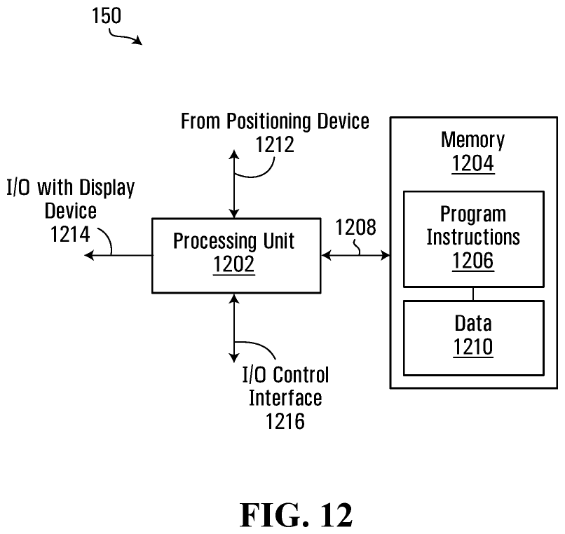

In a non-limiting example, some or all the functionality of the processing system 150 may be implemented on a suitable microprocessor 1200 of the type depicted in FIG. 12. Such a microprocessor 1200 typically includes a processing unit 1202 and a memory 1204 that is connected thereto by a communication bus 1208. The memory 1204 includes program instructions 1206 and data 1210. The processing unit 1202 is adapted to process the data 1210 and the program instructions 1206 in order to implement the functionality described and depicted in the drawings with reference to the system 100 or 100′ and more specifically with reference to the flow diagrams shown in FIG. 3A and FIG. 3B and described earlier. The microprocessor 1200 may also comprise one or more I/O interfaces for receiving and/or sending data elements to external modules. In particular, the microprocessor 1200 may comprise an I/O interface 1212 for exchanging data with the positioning system 120 or an I/O interface 1214 for exchanging signals with an output device (such as a display device) and an I/O interface 1216 for exchanging signals with a control interface. The output device and the control interface may be shown on the same interface, for example a touch-sensitive screen.

### Mathematical Tools for Precision Determination Methods: Jacobian Matrices of a Compound and Inverse Transformations

For the reader's ease of reference, below are included some explanations pertaining to mathematical tools and models that may be used to implement certain aspects of the processes and devices presented herein. It is to be appreciated that these explanations are provided here for the purpose of illustration and that other mathematical tools/models for achieving the features described in the present disclosure may be used in alternative implementations.

In this example, the pose of an object in 3D space is parameterized using 3 angles and 3 coordinates. Rotation angles may be set using a convention for Roll (χ), Pitch (β) and Yaw (α). Thus, a pose of the object may be parameterized by a vector p=(χ, β, α, x, y, z)^{T}. A rotation matrix in Euclidean space can be represented by three orthogonal unit vectors as follows:

$$R = ( \begin{matrix}{n}_{x} & {o}_{x} & {a}_{x} \\ {n}_{y} & {o}_{y} & {a}_{y} \\ {n}_{z} & {o}_{z} & {a}_{z}\end{matrix} ) = ( n \vert o \vert a ) \qquad Equation 13$$

Measurement of uncertainties (or levels of precision) from two measured poses (for example the pose of the object 110 and the pose of the measuring instrument 130 or 130′) by the positioning system (such as positioning system 120) may be used for estimating a total level of precision of the overall system. Moreover, to estimate levels of precision within a working volume in real time after observing visual targets on both the object and the measuring instrument, and where some visual targets might be occluded, a calculation procedure may be defined in practical implementations.

Another possibility includes searching for the pose that minimizes the alignment error (the best fit) between the 3D visual target model of the object or 3D visual target model of the measuring instrument, with the measured 3D position of the visible visual targets obtained using two or more cameras of the positioning system 120. Using two cameras or more makes it possible to increase a level of precision and match errors in 3D space as opposed to the use of reprojection errors.

Calculated pose parameters can be used to apply linearization. Consider a general estimation problem where a nonlinear relationship f is defined between independent variables xᵢ and unknown parameters that will be estimated, and that are represented by vector β of dimension n=dim(β) along with observations of dependent variables yᵢ subject to noise ϵᵢ:

$$y = f ( x , β ) + ϵ \qquad Equation 14$$

After linearizing f, one will end up with a least square estimation problem where a number of observations that is superior to the number of parameters to estimate, m=dim(y), will make it possible to approximate the covariance matrix of the estimated parameter \hat{β} by:

$${Λ}_{\hat{β}} = {{\hat{σ}}^{2} ( {J}^{t} J )}^{- 1} \qquad Equation 15$$

where J=∂f/∂\hat{β} represents the Jacobian matrix and \hat{σ} represents the standard deviation estimate of the noise measurement ϵᵢ with

$$\hat{σ} = \frac{\sum {r}_{i}^{2}}{m - n} ,$$

and with r=y−f(x, \hat{β}).

At the end of the process, one has obtained a 6×6 covariance matrix of the transformation parameters.

### Jacobian Matrix of a Compound Transformation

For a homogeneous transform T₃=T₁T₂, one will obtain:

$${T}_{3} \to ( \begin{matrix}{χ}_{3} \\ {β}_{3} \\ {α}_{3} \\ {x}_{3} \\ {y}_{3} \\ {z}_{3}\end{matrix} ) = ( \begin{matrix}{A}_{3} \\ {t}_{3}\end{matrix} ) \qquad Equation 16$$

$$where {T}_{1} = ( \begin{matrix}{R}_{1} & {t}_{1} \\ {0}_{1 \times 3} & 1\end{matrix} ) , {T}_{2} = ( \begin{matrix}{R}_{2} & {t}_{2} \\ {0}_{1 \times 3} & 1\end{matrix} ) , {T}_{3} = ( \begin{matrix}{R}_{3} & {t}_{3} \\ {0}_{1 \times 3} & 1\end{matrix} ) and$$

$$\{ {A}_{3} = \begin{matrix}{R}_{3} = {R}_{1} {R}_{2} \\ ( \begin{matrix}atan 2 ( {n}_{{y}_{3}} . {n}_{{x}_{3}} ) \\ atan 2 ( - {n}_{{z}_{3}} , {n}_{{z}_{3}} cos {χ}_{3} + {n}_{{y}_{3}} sin {χ}_{3} ) \\ atan 2 ( {a}_{{x}_{3}} sin {χ}_{3} - {a}_{{y}_{3}} cos {χ}_{3} - {o}_{{x}_{3}} sin {χ}_{3} {o}_{{y}_{3}} cos {χ}_{3} )\end{matrix} ) \\ {t}_{3} = {R}_{1} ( \begin{matrix}{x}_{2} \\ {y}_{2} \\ {z}_{2}\end{matrix} ) + ( \begin{matrix}{x}_{1} \\ {y}_{1} \\ {z}_{1}\end{matrix} )\end{matrix} \qquad Equation 17$$

The Jacobian matrix of the transform J_{c} can thus be expressed as:

$${J}_{c} = \frac{\partial {T}_{3}}{\partial ( {T}_{1} , {T}_{2} )} = ( {J}_{{c}_{1}} \vert {J}_{{c}_{2}} ) = ( \begin{matrix}{K}_{1} & {0}_{3 \times 3} & {K}_{2} & {0}_{3 \times 3} \\ M & {I}_{3 \times 3} & {0}_{3 \times 3} & {R}_{1}\end{matrix} ) \qquad Equation 18$$

$$\{ \begin{matrix}M = ( \begin{matrix}- ( {y}_{3} - {y}_{1} ) & ( {z}_{3} - {z}_{1} ) cos {χ}_{1} & {a}_{{x}_{1}} {y}_{2} - {o}_{{x}_{1}} {z}_{2} \\ {x}_{3} - {x}_{1} & ( {z}_{3} - {z}_{1} ) sin {χ}_{1} & {a}_{{y}_{1}} {y}_{2} - {o}_{{y}_{1}} {z}_{2} \\ 0 & - {x}_{2} cos {β}_{1} - {y}_{2} sin {β}_{1} sin {α}_{1} - {z}_{2} sin {β}_{1} cos {α}_{1} & {a}_{{z}_{1}} {y}_{2} - {o}_{{z}_{1}} {z}_{2}\end{matrix} ) \\ {K}_{1} = ( \begin{matrix}1 & \frac{sin {β}_{3} sin ( {χ}_{3} - {χ}_{1} )}{cos {β}_{3}} & \frac{{o}_{{x}_{2}} sin {α}_{3} + {a}_{{x}_{2}} cos {α}_{3}}{cos {β}_{3}} \\ 0 & cos ( {χ}_{3} - {χ}_{1} ) & - cos {β}_{1} sin ( {χ}_{3} - {χ}_{1} ) \\ 0 & \frac{sin ( {χ}_{3} - {χ}_{1} )}{cos {β}_{3}} & \frac{cos {β}_{1} cos ( {χ}_{3} - {χ}_{1} )}{cos {β}_{3}}\end{matrix} ) \\ {K}_{2} = ( \begin{matrix}\frac{cos {β}_{2} cos ( {α}_{3} - {α}_{2} )}{cos {β}_{3}} & \frac{sin ( {α}_{3} - {α}_{2} )}{cos {β}_{3}} & 0 \\ - cos {β}_{2} sin ( {α}_{3} - {α}_{2} ) & cos ( {α}_{3} - {α}_{2} ) & 0 \\ \frac{{a}_{{x}_{1}} cos {χ}_{3} + {a}_{{y}_{1}} sin {χ}_{3}}{cos {β}_{3}} & \frac{sin {β}_{3} sin ( {α}_{3} - {α}_{2} )}{cos {β}_{3}} & 1\end{matrix} )\end{matrix} \qquad Equation 19$$

### Jacobian Matrix of an Inverse Transformation

Let T⁻¹ be the inverse transformation of T. Let also pᵢ=(χᵢ, βᵢ, αᵢ, xᵢ, yᵢ, zᵢ)^{T} be the parameters of the inverse transformation given the parameters p=(χ, β, α, x, y, z)^{T} of the initial transformation:

$${T}^{- 1} = ( \begin{matrix}{χ}_{i} \\ {β}_{i} \\ {α}_{i} \\ {x}_{i} \\ {y}_{i} \\ {z}_{i}\end{matrix} ) = ( \begin{matrix}atan 2 ( {o}_{x} , {n}_{x} ) \\ atan 2 ( - {a}_{x} , {n}_{x} cos {χ}_{i} + {o}_{x} sin {χ}_{i} ) \\ atan 2 ( {n}_{x} sin {χ}_{i} - {o}_{z} cos {χ}_{i} - {n}_{y} sin {χ}_{i} + {o}_{y} sin {χ}_{i} ) \\ - ( {n}_{x} x + {n}_{y} y + {n}_{z} z ) \\ - ( {o}_{x} x + {o}_{y} y + {o}_{z} z ) \\ - ( {a}_{x} x + {a}_{y} y + {a}_{z} z )\end{matrix} ) \qquad Equation 20$$

The Jacobian matrix, Jᵢ, becomes:

$${J}_{i} = \frac{\partial {T}^{- 1}}{\partial T} = ( \begin{matrix}Q & {O}_{3 \times 3} \\ N & - {R}^{T}\end{matrix} ) \qquad Equation 21$$

$$with$$

$$\{ \begin{matrix}N = ( \begin{matrix}{n}_{y} x - {n}_{x} y & - {n}_{z} x cos χ - {n}_{z} y sin χ + z cos β & 0 \\ {o}_{y} x - {o}_{x} y & - {o}_{z} x cos χ - {o}_{z} y sin χ + z sin β sin α & {z}_{i} \\ {a}_{y} x - {a}_{x} y & - {a}_{z} x cos χ - {a}_{z} y sin χ + z sin β cos α & - {y}_{i}\end{matrix} ) \\ Q = ( \begin{matrix}\frac{- {a}_{z}}{1 - {a}_{x}^{2}} & \frac{- {a}_{y} cos χ}{1 - {a}_{x}^{2}} & \frac{{n}_{x} {a}_{x}}{1 - {a}_{x}^{2}} \\ \frac{{a}_{y}}{\sqrt{1 - {a}_{x}^{2}}} & \frac{- {a}_{x} cos χ}{\sqrt{1 - {a}_{x}^{2}}} & \frac{{o}_{x}}{\sqrt{1 - {a}_{x}^{2}}} \\ \frac{{a}_{x} {a}_{z}}{1 - {a}_{x}^{2}} & \frac{- {o}_{x} cos α}{1 - {a}_{x}^{2}} & \frac{- {n}_{x}}{1 - {a}_{x}^{2}}\end{matrix} )\end{matrix} \qquad Equation 22$$

Note that titles or subtitles may be used throughout the present disclosure for convenience of a reader, but in no way these should limit the scope of the invention.

In some embodiments, any feature of any embodiment described herein may be used in combination with any feature of any other embodiment described herein.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps. As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

In describing embodiments, specific terminology has been resorted to for the sake of description, but this is not intended to be limited to the specific terms so selected, and it is understood that each specific term comprises all equivalents. In case of any discrepancy, inconsistency, or other difference between terms used herein and terms used in any document incorporated by reference herein, meanings of the terms used herein are to prevail and be used.

References cited throughout the specification are hereby incorporated by reference in their entirety for all purposes.

Although various embodiments of the disclosure have been described and illustrated, it will be apparent to those skilled in the art in light of the present description that numerous modifications and variations can be made. The scope of the invention is defined more particularly in the appended claims.

What is claimed is:

1. A method implemented by a computing system for providing measurement precision indications for a photogrammetric system, the photogrammetric system comprising a positioning system with at least one optical device and a measuring instrument configured to take 3D measurements of a surface of an object, the method comprising:
a. receiving, at the computing system, information representing locations of visual targets within a field of view of the at least one optical device, wherein the visual targets include object visual targets affixed on at least one of:
i. the surface of the object; and
ii. on another surface immobile relative to the surface of the object;
b. processing, at the computing system, the locations of the visual targets within the field of view of the at least one optical device for deriving information conveying a volume within which 3D measurements of the surface of the object taken by the measuring instrument satisfy a threshold level of precision; and
c. releasing data conveying the derived volume within which the 3D measurements of the surface of the object taken by the measuring instrument satisfy the threshold level of precision thereby providing a user with the measurement precision indications for the photogrammetric system.

2. (canceled)

3. The method of claim 1, wherein deriving the information conveying the volume within which 3D measurements of the surface of the object taken by the measuring instrument satisfy the threshold level of precision includes:
a. processing the locations of the visual targets within the field of view of the at least one optical device to derive:
i. a first pose estimation corresponding to a pose of the measuring instrument with respect to the positioning system; and
ii. a second pose estimation corresponding to a pose of the object with respect to the positioning system;
b. processing the first pose estimation and the second pose estimation to derive precision indicator values for a plurality of voxels in the field of view the at least one optical device; and
c. processing the precision indicator values for the plurality of voxels in the field of view of the at least one optical device and the threshold level of precision to derive the volume within which 3D measurements of the surface of the object taken by the measuring instrument satisfy the threshold level of precision.

4. The method define in claim 1, wherein the visual targets within the field of view of the at least one optical device includes the one or more object visual targets and one or more measuring instrument visual targets affixed to the measuring instrument, and wherein deriving the information conveying the volume within which 3D measurements of the surface of the object taken by the measuring instrument satisfy the threshold level of precision includes:
a. processing the locations of the one or more measuring instrument visual targets within the field of view of the at least one optical device to derive a first pose estimation corresponding to a pose of the measuring instrument with respect to the positioning system;
b. processing the locations of the one or more object visual targets within the field of view of the at least one optical device to derive a second pose estimation corresponding to a pose of the object with respect to the positioning system;
c. processing the first pose estimation and the second pose estimation to derive precision indicator values for a plurality of voxels in the field of view the at least one optical device; and
d. processing the precision indicator values for the plurality of voxels in the field of view the at least one optical device and the threshold level of precision to derive the volume within which 3D measurements of the surface of the object taken by the measuring instrument satisfy the threshold level of precision.

5. The method of claim 3, wherein processing the first pose estimation and the second pose estimation to derive the precision indicator values includes:
a. processing the first pose estimation and the second pose estimation to derive a compound pose estimation corresponding to a pose of the measuring instrument with respect to the object,
b. processing the compound pose estimation to derive the precision indicator values for the plurality of voxels in the field of view the at least one optical device.

6. The method of claim 1, wherein the threshold level of precision is one of a default threshold and a value specified by the user at the computing system.

7. The method of claim 1, comprising:
a. Directing the computing system to implement a Graphical User Interface (GUI) for displaying a visual representation of the field of view of the at least one optical device of the positioning system; and
b. processing the data conveying the derived volume to render on the GUI a graphical representation including a volumetric shape corresponding to the derived volume within which the 3D measurements of the surface of the object taken by the measuring instrument satisfy the threshold level of precision, thereby providing the user with the measurement precision indications for the photogrammetric system.

8. The method of claim 7, wherein the threshold level of precision is one of a plurality of threshold levels of precision including two or more distinct threshold levels of precision, said method comprising processing the locations of the visual targets for deriving information conveying a plurality of volumes within which 3D measurements of the surface of the object taken by the measuring instrument, volumes in the plurality of volumes satisfying corresponding specific threshold levels of precision in said plurality of threshold levels of precision.

9. The method of claim 8, said method comprising:
a. rendering on the GUI a graphical representation of at least two derived volumes in the plurality of volumes within which 3D measurements of the surface of the object taken by the measuring instrument satisfy corresponding threshold levels of precision in the plurality of threshold levels of precision.

10. The method of claim 7, wherein the volumetric shape includes a bounding envelope corresponding to the threshold level of precision, the bounding envelope having a generally spherical or polyhedral shape.

11. The method of claim 7, wherein the threshold level of precision is a first threshold level of precision and wherein the plurality of threshold levels of precision include a second threshold level of precision different from said first threshold level of precision, said volumetric shape including a first bounding envelope corresponding to the first threshold level of precision and a second bounding envelope corresponding to the second threshold level of precision, wherein the second bounding envelope is fully contained withing said first bounding envelope.

12. (canceled)

13. The method of claim 7, comprising:
a. receiving, at the computing system, information representing locations of one or more additional visual targets;
b. processing, at the computing system, the locations of the visual targets in combination with the locations of the one or more additional visual targets within the field of view of the at least one optical device for deriving updated information conveying an updated volume within which 3D measurements of the surface of the object taken by the measuring instrument satisfy the threshold level of precision; and
c. dynamically adapting the GUI to display an updated volumetric shape corresponding to the derived updated volume.

14. The method of claim 7, comprising displaying a CAD geometric model of the object on the GUI overlaid with the displayed graphical representation including the volumetric shape corresponding to the derived volume.

15. (canceled)

16. (canceled)

17. The method of claim 1, comprising processing the derived volume to provide an indication to the user that the measuring instrument is scanning a zone outside the derived volume within which the 3D measurements of the surface of the object taken by the measuring instrument satisfy the threshold level of precision, wherein the indication includes at least one of an audible signal, haptic feedback and a visual signal.

18. (canceled)

19. The method of claim 17, wherein the indication includes the visual signal, the visual signal including at least one of a color change on an element of a GUI and a flashing icon.

20. (canceled)

21.-41. (canceled)

42. A photogrammetric system for generating 3D data relating to a surface of a target object, the photogrammetric system comprising:
a. a positioning system having at least one optical device;
b. a measuring instrument configured to take 3D measurements of a surface of the target object;
c. a computing system in communication with the positioning system, the computing system being configured for:
i. receiving information representing locations of visual targets within a field of view of the at least one optical device, wherein the visual targets include object visual targets affixed on at least one of:
1. the surface of the object; and
2. on another surface immobile relative to the surface of the object;
ii. processing the locations of the visual targets within the field of view of the at least one optical device for deriving information conveying a volume within which 3D measurements of the surface of the object taken by the measuring instrument satisfy a threshold level of precision; and
iii. releasing data conveying the derived volume within which the 3D measurements of the surface of the object taken by the measuring instrument satisfy the threshold level of precision thereby providing the user with the measurement precision indications for the photogrammetric system.

43. (canceled)

44. The photogrammetric system defined in claim 42, wherein deriving the information conveying the volume within which 3D measurements of the surface of the object taken by the measuring instrument satisfy the threshold level of precision includes:
a. processing the locations of the visual targets within the field of view of the at least one optical device to derive:
i. a first pose estimation corresponding to a pose of the measuring instrument with respect to the positioning system; and
ii. a second pose estimation corresponding to a pose of the object with respect to the positioning system;
b. processing the first pose estimation and the second pose estimation to derive precision indicator values for a plurality of voxels in the field of view the at least one optical device; and
c. processing the precision indicator values for the plurality of voxels in the field of view the at least one optical device and the threshold level of precision to derive the volume within which 3D measurements of the surface of the object taken by the measuring instrument satisfy the threshold level of precision.

45. The photogrammetric system defined in claim 44, wherein the visual targets within the field of view the at least one optical device includes the one or more object visual targets and one or more measuring instrument visual targets affixed to the measuring instrument, and wherein deriving the information conveying the volume within which 3D measurements of the surface of the object taken by the measuring instrument satisfy the threshold level of precision includes:
a. processing the locations of the one or more measuring instrument visual targets within the field of view of the at least one optical device to derive a first pose estimation corresponding to a pose of the measuring instrument with respect to the positioning system;
b. processing the locations of the one or more object visual targets within the field of view of the at least one optical device to derive a second pose estimation corresponding to a pose of the object with respect to the positioning system;
c. processing the first pose estimation and the second pose estimation to derive precision indicator values for a plurality of voxels in the field of view the at least one optical device; and
d. processing the precision indicator values for the plurality of voxels in the field of view the at least one optical device and the threshold level of precision to derive the volume within which 3D measurements of the surface of the object taken by the measuring instrument satisfy the threshold level of precision.

46. (canceled)

47. (canceled)

48. The photogrammetric system of claim 42, said computing system being configured for:
a. implementing a Graphical User Interface (GUI) for displaying a visual representation of the field of view of the at least one optical device of the positioning system;
b. processing the data conveying the derived volume to render on the GUI a graphical representation including a volumetric shape corresponding to the derived volume within which the 3D measurements of the surface of the object taken by the measuring instrument satisfy the threshold level of precision, thereby providing the user with the measurement precision indications for the photogrammetric system.

49. The photogrammetric system of claim 48, wherein the threshold level of precision is one of a plurality of threshold levels of precision including two or more distinct threshold levels of precision, said computing system being configured for processing the locations of the visual targets for deriving information conveying a plurality of volumes within which 3D measurements of the surface of the object taken by the measuring instrument, volumes in the plurality of volumes satisfying corresponding specific threshold levels of precision in said plurality of threshold levels of precision, said computing system being configured for rendering on the GUI a graphical representation of at least two derived volumes in the plurality of volumes within which 3D measurements of the surface of the object taken by the measuring instrument satisfy corresponding threshold levels of precision in the plurality of threshold levels of precision.

50. (canceled)

51. The photogrammetric system of claim 48, wherein the volumetric shape includes a bounding envelope corresponding to the threshold level of precision, wherein the bounding envelope has a generally spherical or polyhedral shape.

52. (canceled)

53. (canceled)

54. The photogrammetric system of claim 48, said computing system being configured for:
a. receiving, at the computing device, information representing locations of one or more additional visual targets;
b. processing, at the computing device, the locations of the visual targets in combination with the locations of the one or more additional visual targets within the field of view of the at least one optical device for deriving updated information conveying an updated volume within which 3D measurements of the surface of the object taken by the measuring instrument satisfy the threshold level of precision;
c. dynamically adapting the GUI to display an updated volumetric shape corresponding to the derived updated volume.

55. (canceled)

56. (canceled)

57. The photogrammetric system of claim 42, wherein the measuring instrument is one of a touch probe and a handheld optical scanner.

58. The photogrammetric system of claim 42, said computing system being configured for processing the derived volume to provide an indication to the user that the measuring instrument is scanning a zone outside the derived volume within which the 3D measurements of the surface of the object taken by the measuring instrument satisfy the threshold level of precision, wherein the indication includes at least one of an audible signal, haptic feedback and a visual signal.

59. (canceled)

60. (canceled)

61. The photogrammetric system of claim 42, wherein the one or more optical devices of the positioning system include at least one camera.

62. A method for providing measurement precision indications for a photogrammetric system, the photogrammetric system comprising a positioning system with at least one optical device and a measuring instrument configured to take 3D measurements of a surface of an object, the method comprising:
a. processing information representing locations of visual targets within a field of view of the at least one optical device to derive level of precision information associated with the 3D measurements; and
b. releasing data conveying the derived level of precision information.

63.-75. (canceled)
